(19) United States
(12) Patent Application Publication
(10) Pub. No.: US 2008/0059242 A1
(43) Pub. Date: Mar. 6, 2008

(54) HEALTH INFORMATION MANAGEMENT SYSTEM AND METHOD

(75) Inventor: Alan Stanford, Indianapolis, IN (US)

Correspondence Address: ICE MILLER LLP, ONE AMERICAN SQUARE, SUITE 3100, INDIANAPOLIS, IN, 46282-0200, US

(73) Assignee: My Health Care Manager, LLC, Indianapolis, IN (US)

(21) Appl. No.: 11/754,168

(22) Filed: May 25, 2007

Related U.S. Application Data
(60) Provisional application No. 60/808,772, filed on May 26, 2006.

(51) Int. Cl. G06F 17/00

(52) U.S. Cl. 705/3; 707/104.1

(57) ABSTRACT

A health care management system and method. In one embodiment, a health care management system comprises a database capable of receiving data; a processor operably connected to the database, the processor having and executing a program and operational to receive patient data associated with a patient, said patient data obtained from at least one patient visit; perform a multidimensional screening assessment of the patient information; generate data from the multidimensional screening assessment; store in the database at least part of the patient data and at least part of the multidimensional screening assessment data; and generate at least one report from the stored data in the database. In another embodiment, the at least one member visit comprises one or more visits selected from the group consisting of a home visit, a provider visit, a phone consult, a pharmacy visit, and a family communication.

### RELATED APPLICATION

The present non-provisional application is related to and claims the benefit of U.S. Provisional Patent Application Ser. No. 60/808,772, entitled “HEALTH INFORMATION MANAGEMENT SYSTEM AND METHOD,” filed on May 26, 2006

### BACKGROUND

The present application relates to systems and methods for managing health information, and, in particular, to such health information of senior citizens or other individuals actively engaged in health care activities for themselves and/or their families.

Navigating today's health care “system” is a complex challenge and problem, particularly for the generation over 70 years old. Such navigation is difficult because the system is not an integrated system but, rather, comprises a vast assortment of unrelated providers and services. Further complicating this problem is the fact that each of the various entities is often unaware of the other's involvement, recommendations, and treatment plans. Understanding insurance coverage, complying with claims procedures, and contesting denied or reduced payments within this health care puzzle only adds to the complexity. As seniors age or a person's health conditions change, the problem often becomes more convoluted. Unfortunately, many seniors and other individuals are forced to face this system alone or with their family, without the assistance of knowledgeable advisors.

Automated or computer-based health care systems currently in use are heavily weighted toward the delivery of care (i.e., appointments), to the collection of payments, or toward the processing of insurance claims Many of these initiatives are centered on an Electronic Health Record (EHR) or Electronic Medical Record (EMR). While such systems provide a hospital, doctor, therapist, or even an insurance company with useful information, they do little to directly impact the people most affected, i.e., the senior or other individual within a care regimen. The few interactions with these systems which do exist, such as Explanation Of Benefit (EOB) statements, are often confusing and frustrating No information is available from these systems on care plans, medications, multiple disease states, life style, state of mind, living circumstances, support networks, caregivers, and/or the other complexities faced by seniors or others actively involved in healthcare activities. Further, the prior art systems do not represent a holistic picture of the environment impacting independence and quality of life.

The Personal Health Record (PHR) and Electronic Public Health Record (EPHR) have been developed in response to this need. Though their focus is different, these systems provide a way for individuals to build and maintain a health care record independent of their health care provider. In some cases, these systems provide access to providers or government agencies for emergencies or even input to the health record itself. Even when such access is provided, the systems are largely dependent on input from individuals and/or their families. Health care providers have little time or incentive to maintain this data external to their practice. In addition, these providers typically interact with an individual only on part of their overall health circumstance. This reliance on the individual's understanding of their health situation and care plans presents a challenge to the completeness and accuracy of the health care record.

The few solutions considered in the health industry for the integration of patient medical information depend on the voluntary input of doctors and other health professionals. Some experts observe that these professionals are extremely busy in the daily practice of medicine and have little financial incentive to work with these systems. It would place even higher demands on health care providers to add case management and family/advisor/insurance information. It is desirable to provide a management system that recognizes the current state and realities of the health care delivery system and does not rely on any major changes to the current health care environment, but that would coordinate and collaborate with them when available.

The older adult market for a good health care management system is extremely large. The current population of persons in the United States 65 and older is approximately 50 million of which a significant portion of that population could benefit from a system addressing the shortcomings of prior art systems. According to U.S. Census projections, continuing growth is strong as the overall demographic is growing at more than 10% annually.

### BRIEF SUMMARY

The present application relates to systems and methods for managing health information, and, in particular, to such health information of senior citizens or others actively involved in health care activities for themselves or their families.

One embodiment of the system of the present application, My Health Care Manager™, takes a new approach to address shortcomings or prior systems by adding the judgment and input of an experienced nurse or social worker, a Health Care Manager, to the process of building the Personal Health Care Record. This process takes place over a series of in-home and telephone visits with the Member, their family, and in the consultation portion of provider office visits, when appropriate. The Health Care Manager builds the information through direct examination of prescription medication labeling, provider visit records such as the super bill, a formalized initial assessment, and a repeated reassessment process.

A new model for deploying and accessing important health information is possible by using secure Internet (or other network) technology (whether wired and/or wireless) to make information available to persons and their loved ones regardless of location, time zones, and schedules.

A technology platform is designed to deliver increased direct interactions between Health Care Managers and their Members and Member families. A “Member” is an individual who subscribes to the services described herein. Designed to meet Health Insurance Portability and Accountability Act (HIPAA) requirements, the architecture of the system of the system of the p present application allows Health Care Managers to collect, assimilate, and rapidly process relevant health information and to make that information available to all authorized people simultaneously. With technology assisting in the communications, the Health Care Manager is able to concentrate on effective one-to-one verbal communications with the person.

No medical care is provided by the a service provider or the Health Care Manager; rather, a service provider helps manage, or “navigate,” the care and services provided by others. Further, all services provided are objective and independent of health care service providers, and no referral fees or commissions may be accepted by a company service provider or its Health Care Managers. The service program is flexible and requires no long-term commitment. Following one-time initial services, Members select from monthly program levels. The levels of service are designed to provide different degrees of service depending upon the Member's current needs and are adapted to their changing needs. Optional Additional Services are also available.

Continuous quality measurement and improvement provided through My Health Care Manager's core computer systems will introduce another new approach to helping seniors. The systems will support and enforce the service delivery standards of the company and provide feedback on outcomes, appropriateness, frequency, and content of the services provided to Members. This data, under proper HIPAA compliance, provides valuable research data for the health care profession, as well. Uniquely, the database built by My Health Care Manager combines observations of health conditions with ten (10) other areas including functional, cognitive, nutritional, caregiver strain, environmental, and other circumstances affecting health situations. It is believed that analysis of this cross connected data will provide new insights in senior care and independent living.

In an embodiment of a health care management system, the system comprises a database capable of receiving data; a processor operably connected to the database, the processor having and executing a program and operational to receive patient data associated with a patient, said patient data obtained from at least one patient visit; perform a multidimensional screening assessment of the patient information; generate data from the multidimensional screening assessment, store in the database at least part of the patient data and at least part of the multidimensional screening assessment data; and generate at least one report from the stored data in the database. In another embodiment of a health care management system the at least one member visit comprises one or more visits selected from the group consisting of a home visit, a provider visit, a phone consult, a pharmacy visit, and a family communication.

In another embodiment of a health care management: system, the patient data is received by entry of the patient data into a terminal within the system. In yet another embodiment, the multidimensional screening assessment comprises one or more assessments selected from the group consisting of home safety, member depression, and a member's social support network. In another embodiment, the multidimensional screening assessment comprises one or more dimensions of the multidimensional screening assessment selected from the group consisting of demographic information, family, social support, representatives and key contacts, financial, legal, insurance, spiritual, support services, caregiver support, physical health, functional health status, emotional/psychological status, medication history home/residential environment and safety, health prevention, and wellness.

In an additional embodiment of a health care management system, the patient data received by the processor comprises data representative of at least one from the group consisting of member contact information, date of birth, social security number, insurance information, advance directives, related advisors, health care manager contact information, allergies, at least one medical issue, at least one treatment plan, at least one medicine, long-term planning information, family communications information, at least one home visit observation information, and payment information. In another embodiment, the patient data received by the processor comprises data representative of at least one from the group consisting of an electronic health record (EHR), an electronic medical record (EMR), a personal health record (PHR), and an electronic public health record (EPHR). In yet another embodiment, the patient data received by the processor comprises data representative of at least one from the group consisting of non-prescription drug information, medical appointments, exercise and therapy, blood pressure information, target weight information, diet and liquid information, and medicine reordering information.

In an additional embodiment of a health care management system, at least one report comprises a daily and/or weekly schedule. In another embodiment, at least one report generated by the processor comprises a health care record including a member's contact information, at least one medical issue, and at least one medical provider selected from the group consisting of a caregiver/doctor, a prescribing physician, and a provider physician.

In an additional embodiment of a health care management system, at least one report generated by the processor comprises a health care record including at least one item of stored data residing in the database selected from the group consisting of member contact information, date of birth, social security number, insurance information, advance directives, related advisors, health care manager contact information, allergies, at least one medical issue, at least one treatment plan, at least one medicine, long-term planning information, family communications information, at least one home visit observation information.

In another embodiment, at least one report generated by the processor comprises a medicine reorder schedule including at least one item of stored data residing in the database selected from the group consisting of a prescribing physician, at least one prescription medication, a prescription number, at least one non-prescription medication, a medication quantity, a daily dose, an amount of medication refills remaining, a date of next refill, a pharmacy name, and a pharmacy phone number. In yet another embodiment, at least one report generated by the processor comprises a weekly health care schedule including at least one item of stored data residing in the database selected from the group consisting of at least one prescription medication, at least one non-prescription medication, a time to take a medication, a day to take a medication, a list of medicines to take at a specific time, a blood sugar test, and blood sugar test instructions.

In an additional embodiment of a health care management system, at least one report generated by the processor comprises a prescribing doctor verification letter including at least one item of stored data residing in the database selected from the group consisting of a prescribing physician, a provider physician, a member's full name, a narrative, contact information for a health care manager, a prescription medication list, and a non-prescription medication, list. In an additional embodiment, at least one report generated by the processor comprises a ready reference card including at least one item of stored data residing in the database selected from the group consisting of a member's contact information, emergency contacts, contact information for a health care manager, a member's advance directives, hospitalization information, allergies, reactions, a caregiver/doctor, a prescribing physician, insurance information, at least one prescription name, a dose, a time of dose, specific dose parameters, one or more reasons why a member is taking a particular medication, and a date a member began taking a particular medication.

In another embodiment of health care management system, at least one report generated by the processor comprises a contact information record card including at least one item of stored data residing in the database selected from the group consisting of a member's contact information, marital status, other people, account number, contact information for a health care manager, office location information, enrollment date, service level, specific service level details, one or more emergency contacts, and one or more health care designee. In another embodiment, at least one report generated by the processor comprises a personal weekly schedule including at least one item of stored data residing in the database selected from the group consisting of a member's full name, a prescription name, one or more reasons why a member is taking a particular medication, a method for taking a medication, a time of dose, specific dose parameters. In yet another embodiment, at least one report generated by the processor comprises a provider information record including at least one item of stored data residing in the database selected from the group consisting of a member's full name, a caregiver/doctor, a prescribing physician, a provider physician, a first physician specialty, a duration of patient treatment, a date of first physician treatment, at least one medical issue, a clinic/practice name, a physician prescriber confirmation, a date: of last member appointment, a health care plan confirmation, and health care plan issue information.

In an additional embodiment, at least one report generated by the processor comprises a medication record for prescriptions including at least one item of stored data residing in the database selected from the group consisting of a prescription name, a caregiver/doctor, a prescribing physician, a provider physician, a dose, a method of taking a medication, a frequency of daily dose, a time of dose, specific dose parameters, a next refill date, and a prescription number. In an additional embodiment of a health care management system, at least one report generated by the processor comprises a medication record for non-prescription medications, vitamins, and supplements including at least one item of stored data residing in the database selected from the group consisting of a non-prescription name, a caregiver/doctor, a prescribing physician, a provider physician, a dose, a method of taking a medication, a frequency of daily dose, a time of dose, specific dose parameters, a next refill date, and a prescription number.

In another embodiment of a health care management system, at least one report generated by the processor comprises an assessment results and recommendations record including at least one item of stored data residing in the database selected from the group consisting of an assessment number, an assessment completion date, an assessment manager name, an assessment type, an assessment category, an individual score, a total score, scoring guidelines, assessment identification information, at least one immediate goal, and at least one recommendation. In another embodiment, at least one, report generated by the processor comprises a member provider medication record including at least one item of stored data residing in the database selected from the group consisting of a caregiver/doctor, a prescribing physician, a provider physician, a prescription narrative, and a targeted medication summary. In yet another embodiment, at least one report generated by the processor comprises a legal information report including at least one item of stored data residing in the database selected from the group consisting of a living will, a medical power of attorney, a general power of attorney, a do not resuscitate order, a trust officer, a bank manager, a lawyer, an accountant, a broker, a health care agent, and at least one legal recommendation.

In an additional embodiment of a health care management system, at least one report generated by the processor comprises an insurance information report including at least one item of stored data residing in the database selected from the group consisting of Medicare Part A, Medicare Part B, Medicare Part C, Medicare Part D, Medicare Supplement 1, Medicare Supplement 32, long term health care, home health care, other health care, and accidental care.

In an additional embodiment, at least one report generated by the processor comprises a member wishes report including at least one item of stored data residing in the database selected from the group consisting of long-term planning, funeral, burial, and a hospital of choice.

In another embodiment of a health care management system, at least one report generated by the processor comprises a physician appointment plan including at least one item of stored data residing in the database selected from the group consisting of a caregiver/doctor, a prescribing physician a provider physician, and one or more questions. In yet another embodiment, at least one report generated by the processor comprises a member service level contract record including at least one item of stored data residing in the database selected from the group consisting of health care objectives, a meeting summary narrative a future appointment narrative, and an action item narrative.

In an embodiment of a health care management system, the system is accessible by a user through a system portal.

In an embodiment of a computer program, the computer program has a plurality of program steps to be executed on a computer to manage the health care aspects of a member and comprises means for collecting patient data obtained from at least one patient visit; means for receiving multidimensional screening assessment data; means for storing in the database at least part of the patient data and at least part of the multidimensional screening assessment data; and means for generating at least one report from the stored data in the database.

In an embodiment of a computer based method of operating a health care management system, the method comprises providing a system comprising a database and a processor operably connected to the database; receiving patient data associated with a patient, said patient data obtained from at least one patient visit; performing a multidimensional screening assessment of the patient data; generating data from the multidimensional screening assessment; entering with a processor patient data and multidimensional screening assessment data; storing with the processor into a database at least part of the patient data and at least part of the multidimensional screening assessment data; and generating with the processor at least one report from the stored data in the database.

In an embodiment of a health care management systems the system comprises: at least one database comprising data relative to health care, the system operable to analyze data as to procurement of at least one medical appointment, at least one medication, and at least one medical test necessary to generate and/or maintain a health care plan. In another embodiment, the health care management system utilizes an informatics-based service delivery approach comprising at least one database and content developed regarding two or more of the following: service operational and decision support, predictive data mining, and advance quality analytics.

### BRIEF DESCRIPTION OF THE DRAWINGS

The features and advantages of the system of the present application, and the manner of attaining them, will be more apparent and better understood by reference to the following descriptions taken in conjunction with the accompanying drawings, wherein:

FIG. 1 shows a process-flow diagram of one embodiment of a business process of the system of the present application;

FIG. 2 shows a diagram of one embodiment of a technical architecture of the system of the present application;

FIG. 3A shows an embodiment of a first page of a health care record of the system of the present application;

FIG. 3B shows an embodiment of a second page of a health care record of the system of the present application;

FIG. 3C shows an embodiment of a third page of a health care record of the system of the present application;

FIG. 3D shows an embodiment of a fourth page of a health care record of the system of the present application;

FIG. 3E shows an embodiment of a fifth page of a health care record of the system of the present application;

FIG. 3F shows an embodiment of a sixth page of a health care record of the system of the present application;

FIG. 4A shows an embodiment of a first page of a medicine reorder schedule of the system of the present application;

FIG. 4B shows an embodiment of a second page of a medicine reorder schedule of the system of the present application;

FIG. 5A shows an embodiment of a first page of a weekly health care schedule of the system of the present application;

FIG. 5B shows an embodiment of a second page of a weekly health care schedule of the system of the present application;

FIG. 5C shows an embodiment of a third page of a weekly health care schedule of the system of the present application;

FIG. 6A shows an embodiment of a first page of a prescribing doctor verification of the system of the present application;

FIG. 6B shows an embodiment of a second page of a prescribing doctor verification of the system of the present application;

FIG. 7A shows an embodiment of a front of a ready reference card of the system of the present application;

FIG. 7B shows an embodiment of a back of a ready reference card of the system of the present application;

FIG. 8A shows an embodiment of a first page of a contact information record of the system of the present application;

FIG. 8B shows an embodiment of a second page of a contact information record of the system of the present application;

FIG. 9A shows an embodiment of a first page of a personal weekly schedule of the system of the present application;

FIG. 9B shows an embodiment of a second page of a personal weekly schedule of the system of the present application;

FIG. 10 shows an embodiment of a personal weekly schedule for appointments or reminders of the system of the present application;

FIG. 11 shows an embodiment of a provider information record of the system of the present application;

FIG. 12A shows an embodiment of a medication record for prescriptions of the system of the present application;

FIG. 12B shows an embodiment of a medication record for prescriptions with sample data included of the system of the present application;

FIG. 13A shows an embodiment of a medication record for non-prescription medications, vitamins, and supplements of the system of the present application;

FIG. 13B shows an embodiment of a medication record for non-prescription medications, vitamins, and supplements with sample data included of the system of the present application;

FIG. 14A shows an embodiment of a first page of an assessment results and recommendations record of the system of the present application;

FIG. 14B shows an embodiment of a second page of an assessment results and recommendations record of the system of the present application;

FIG. 14C shows an embodiment of a third page of an assessment results and recommendations record of the system of the present application;

FIG. 15A shows an embodiment of a first page of a member provider medication record of the system of the present application;

FIG. 15B shows an embodiment of a second page of a member provider medication record of the system of the present application;

FIG. 15C shows an embodiment of a third page of a member provider medication record of the system of the present application;

FIG. 16 shows an embodiment of a legal information record of the system of the present application;

FIG. 17 shows an embodiment of an insurance information record of the system of the present application;

FIG. 18 shows an embodiment of a member wishes record of the system of the present application;

FIG. 19 shows an embodiment of a physician appointment plan of the system of the present application;

FIG. 20A shows an example of a completed member service level contract record of the system of the present application;

FIG. 20B shows a second example of a completed member service level contract record of the system of the present application;

FIG. 20C shows a third example of a completed member service level contract record of the system of the present application; and

FIG. 21 shows an embodiment of an item selection list of the system of the present application;

FIG. 22 shows an embodiment of a knowledge development layers process; and

FIG. 23 shows an embodiment of results from an iterative visual clustering method applied to system data.

### DETAILED DESCRIPTION

The system of the present application is directed to a system and method for managing health information. For the purposes of promoting an understanding of the principles of the present application, reference will now be made to the embodiments illustrated in the figures, and specific language will be used to describe the same. It will nevertheless be understood that no limitation of the scope of this disclosure is thereby intended.

The system of the present application was created to assist persons utilizing the system of the present application (referred to as “Members”) and their families ill addressing these challenges with greater relative independence and peace of mind. Benefits to Members and their families or caregivers include a strengthened feeling of independence; improved compliance with health care plans, treatments, prescriptions and over-the-counter medications; improved peace of mind for both the Member, his or her caregivers and/or family; and improved communication and awareness to decrease the likelihood of mistakes that could jeopardize the Member's health.

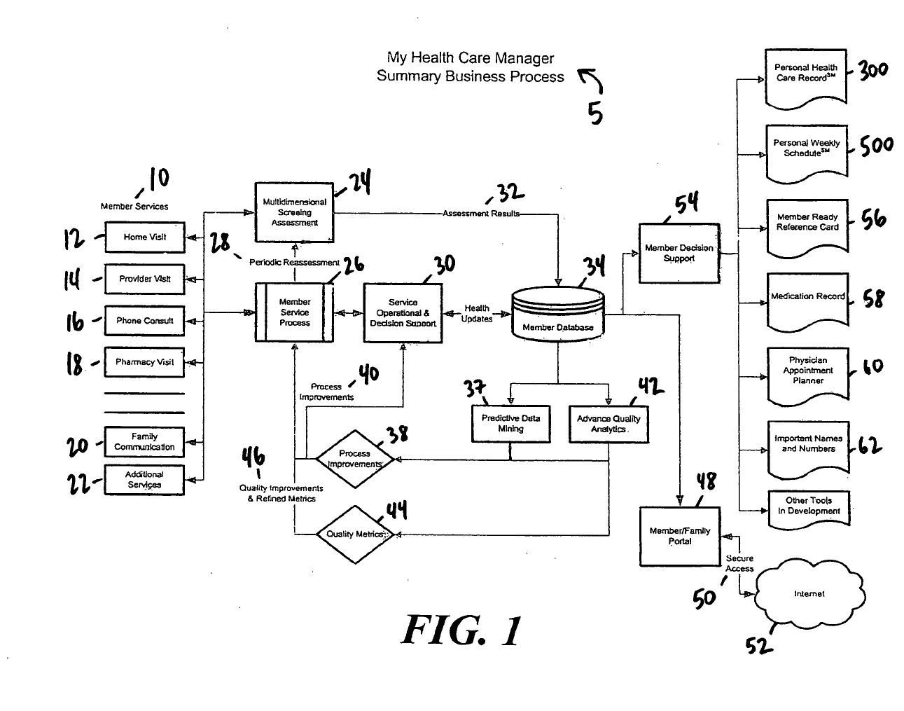

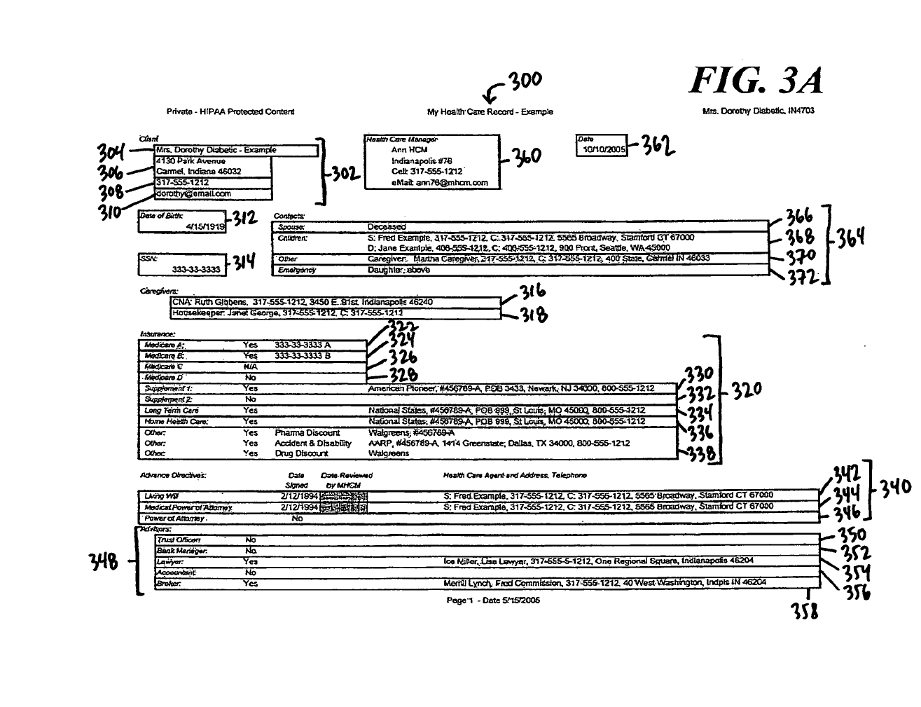

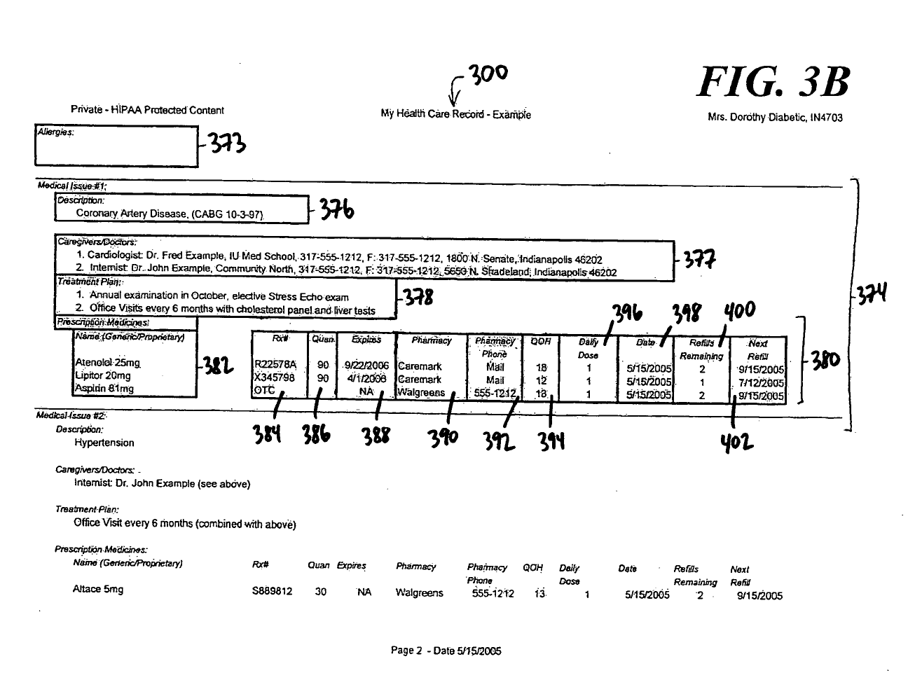

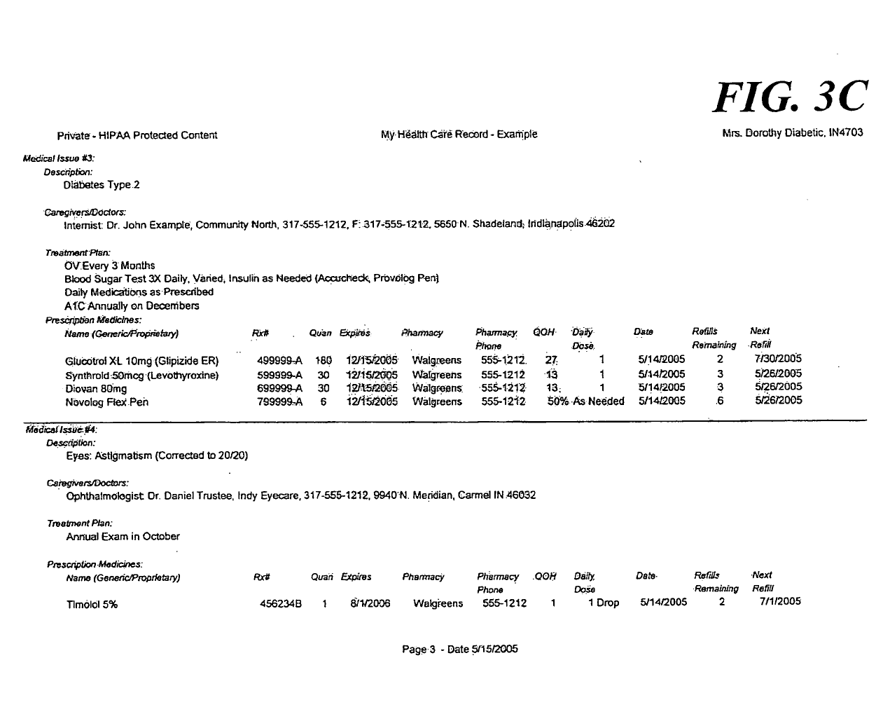

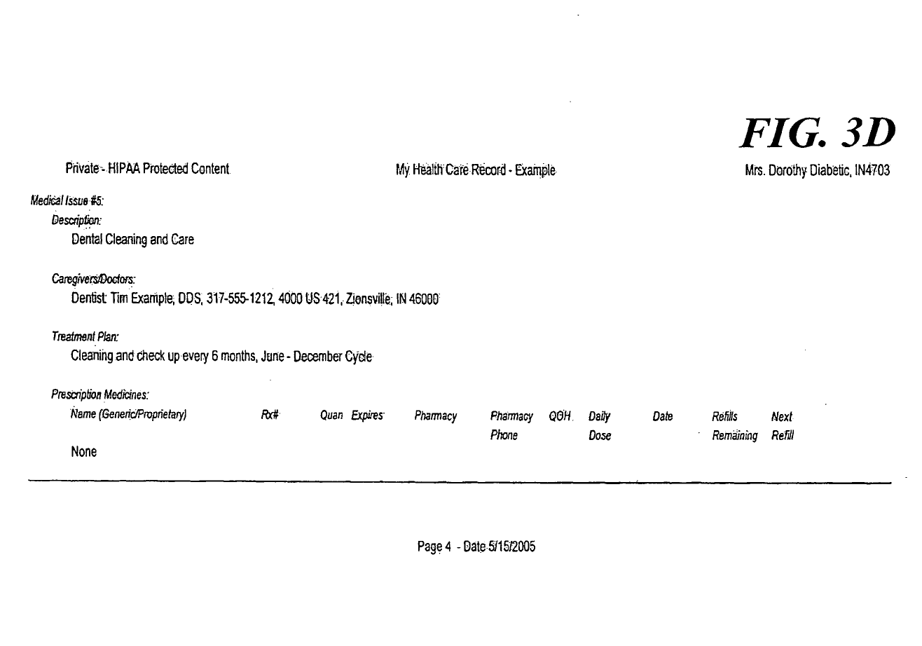

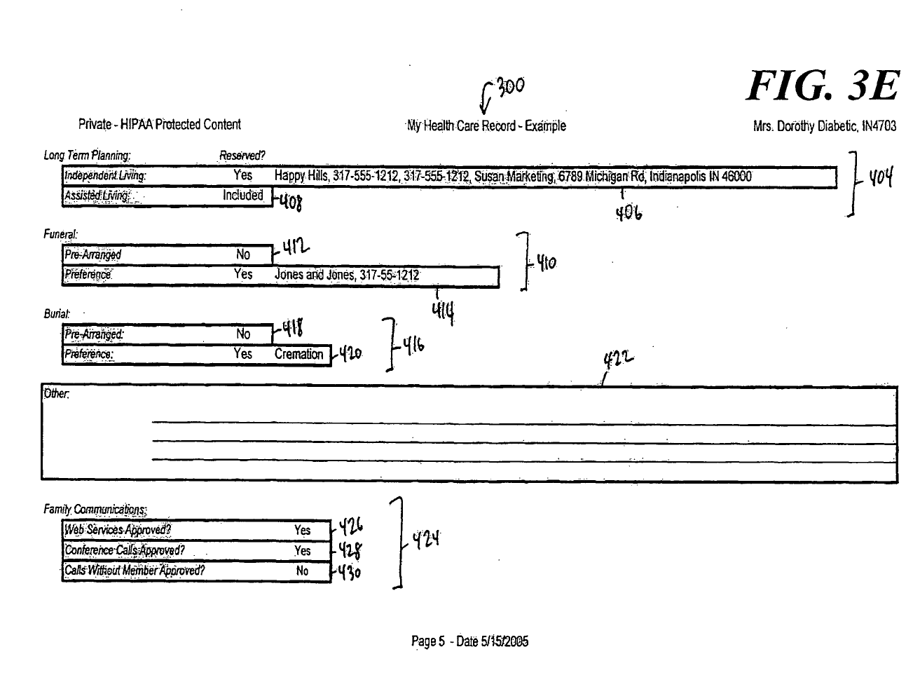

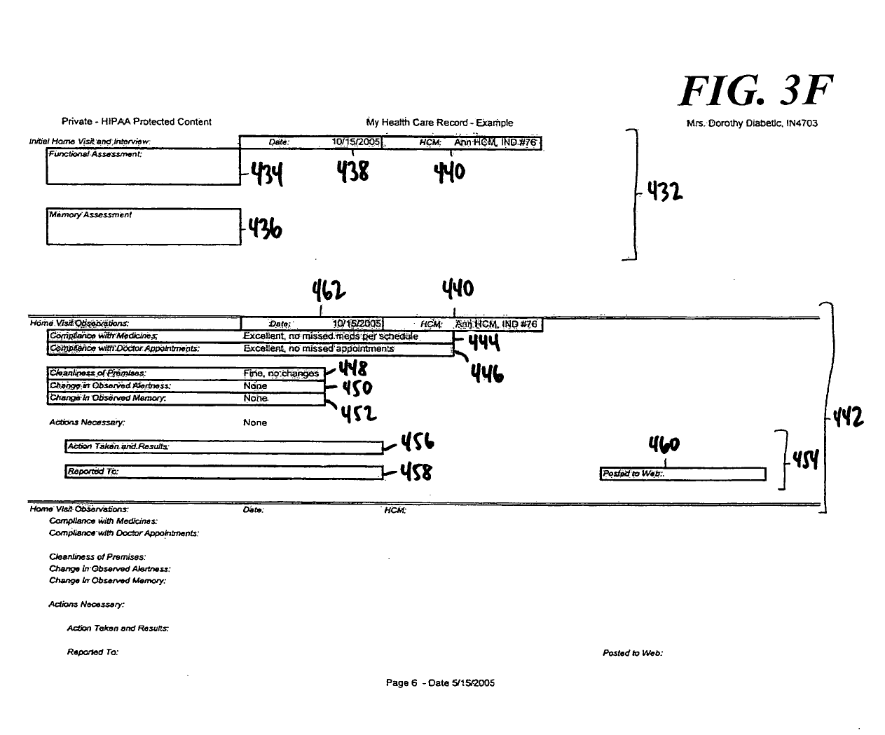

Referring now to FIG. 1, there is shown a business process 5 flowchart of one embodiment of the sources of information, information flow, database(s), and related activities (collectively a “system”) of the present application. In this embodiment, the scope of Member Services 10 may include several sources of information regarding a Member 132 (not shown), including, but not limited to, information about or from at least one Home Visit 12, at least one Provider Visit 14, at least one Phone Consult 16, at least one Pharmacy Visit 18, at least one. Family Communication 20, and at least one Additional Service 22 that may be provided or offered to a Member 132. As discussed herein, the at least one Home Visit 12, the at least one Provider Visit 14, the at least one Phone Consult 16, the at least one Pharmacy Visit 18, the at least one Family Communication 20, and the at least one Additional Service 22 are each referred to as a “Member Visit” and collectively (in groups of two or more) referred to as “Member Visits”. The Member Visits shown in FIG. 1 are representative of the mechanisms used by service providers to obtain detailed Member 132 information. Information regarding a Member 132 (as most clearly referenced in FIG. 3A) may be included with in a Health Care Record 300 (see FIGS. 3A to 3F, for example) of the system of the present application.

As seen in FIGS. 3A to 3F, the Health Care Record 300 may include, but is not limited to, a Member's 132 contact information 302 (full name 304, address 306, home phone number 308, and e-mail address 310), date of birth 312, and social security number 314, some or all of which may be collected from one or more Member Visits. Additional information regarding a Member 132, including caregiver contact information 316 and housekeeper contact information 318, may also be collected resulting from a Member Visit. Insurance information 320 may also be collected, which may include, but is not limited to, information on Medicare Part A 322, Medicare Part B 324, Medicare Part C 326, and Medicare Part D 328, Medicare Supplement 1 330, Medicare Supplement 2 332, long-term health care 334, home health care 336, and other health care 338 of a Member 132.

Information regarding a Member's 132 advance directives 340, which may include, but are not limited to, information regarding a having will 342, medical power of attorney 344, general power of attorney 346, and information regarding related advisors 348, which may include, but is not limited to, information regarding a trust officer 350, a bank manager 352, a lawyer 354, an accountant 356, and a broker 358, may also be collected by a Member Visit. The contact information for a health care manager 360 may also be included on the Health Care Record 300, as well as the date 362 of which the Health Care Record 300 was prepared and/or last updated A health care manager 360 may be the individual to collect a Member's 132 information contained within the Health Care Record 300. The Health Care Record 300 may also include information regarding additional contact information 364 for a Member 132, which may include, but is not limited to, information regarding a Member's 132 spouse 366, children 368, other contacts 370, and emergency contacts 372.

Referring now to FIG. 3B, the Health Care Record 300 may also include information regarding a Member's 132 allergies 373 and at least one medical issue 374. An example of information regarding at least one medical issue 374 of the system of the present application is demonstrated in FIG. 3B, which may include, but is not limited to, information regarding a description 376 of the medical issue 374, at least one caregiver/doctor 377, at least one treatment plan 378, and at least one medicine 380 currently or previously taken by a Member 132. Information regarding the at least one medicine 380 may include, but is not limited to, information regarding a prescription name 382, prescription number 384, quantity 386, expiration date 388, pharmacy name 390, pharmacy phone number 392, quantity on hand 394, daily dose 396, dose date 398, remaining refills 400, and next refill 402. Additional example at least one medical issue 374 information is demonstrated at the bottom of FIG. 3B and on FIGS. 3C and 3D.

Referring now to FIG. 3E, the Health Care Record 300 may also include information regarding a Member's 132 long-term planning 404, which may include, but is not limited to, information regarding independent living 406 and assisted living 408. The Health Care Record 300 may also include funeral 410 information, which may include, but is not limited to, information regarding pre-arrangement 412 and preference 414 of a funeral service provider, and may include burial information 416, which may include, but is not limited to, pre-arrangement 418 and preference 420 of burial. Other long-term planning information 422 may also be included on the Health Care Record 300. In addition, the Health Care Record 300 may include, but is not limited to, information regarding family communications 424, which may include information on web service approval 426, conference call approval 428, and calls without member approval 430 to alert a person referring to the Health Care Record 300 of how a Member 132 has approved family communications 424.

Referring now to FIG. 3F, the Health Care Record 300 may also include information regarding at least one initial home visit and interview 432 of a Member 132, which may include, but is not limited to, information regarding a functional assessment 434 and a memory assessment 436. The date 438 and health care manager information 440 may also be included on the Health Care Record 300 for at least one initial home visit and interview 432. The Health Care Record 300 may also include information regarding at least one home visit observation 442, which may include, but is not limited to, information regarding compliance with medicines 444, compliance with doctor appointments 446, cleanliness: of premises 448, change in observed alertness 450, change in observed memory 452, and actions necessary 454, which may include information on action taken and result 456, reporting 458, and web posting 460. The date 462 and health care manager information 440 may also be included on the Health Care Record 300 for the at least one home visit observation 442.

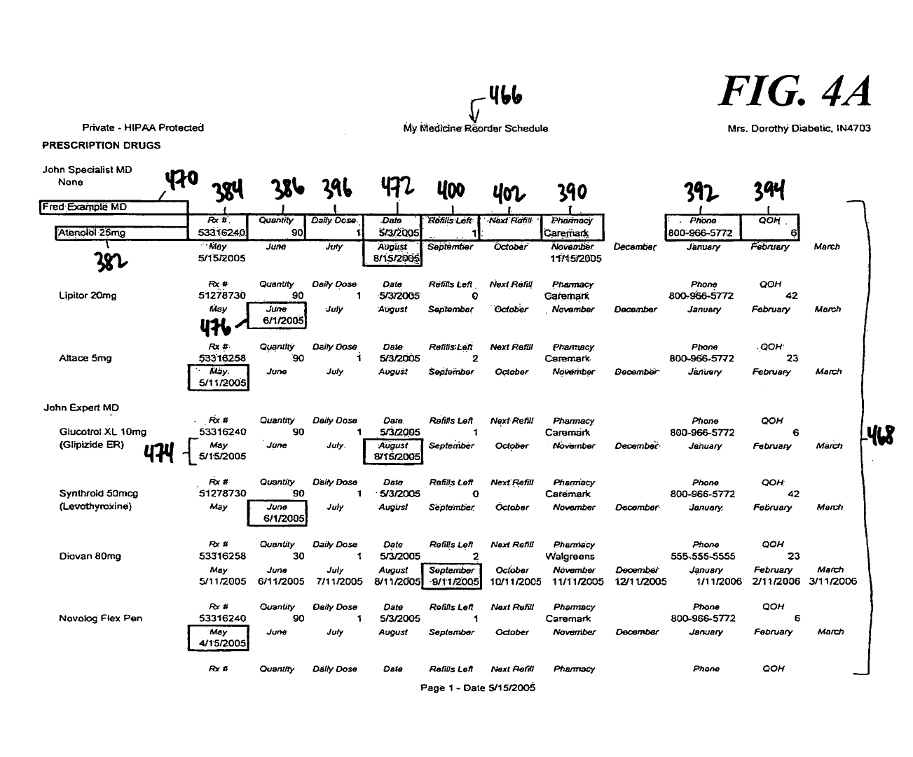

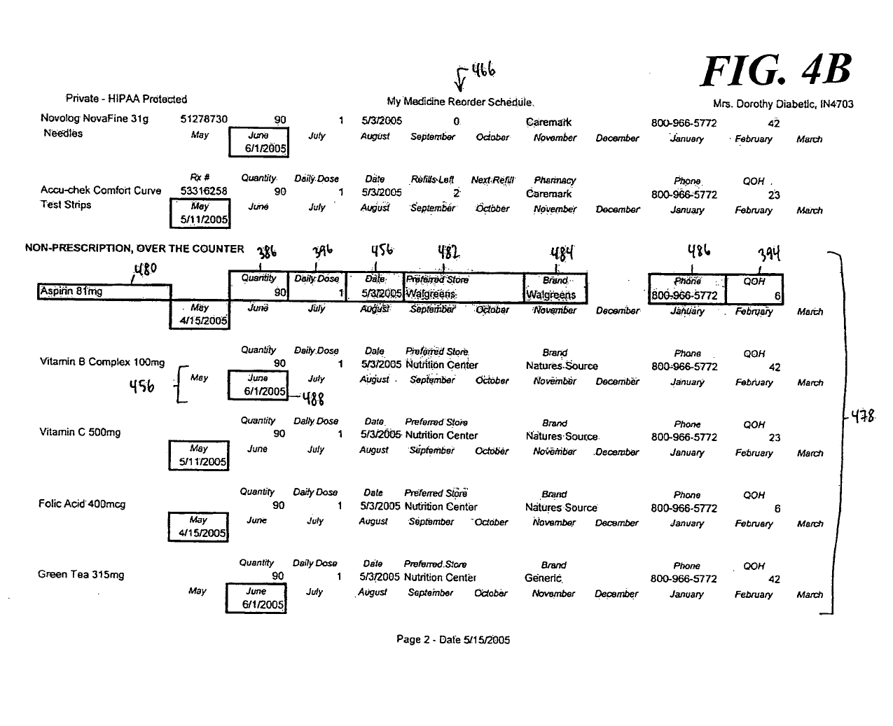

Referring now to FIG. 4A, an: embodiment of a medicine reorder schedule 466 is provided. The medicine reorder schedule 466 may include prescription drug information 468, which may include, but is not limited to, information regarding the prescribing physician 470, the prescription name 382, prescription number 384, quantity 386, daily dose 396, current date 472, remaining refills 400, next refill 402, pharmacy name 390, pharmacy phone number 392, and quantity on hand 394. In addition, a monthly calendar 474 may be included in the medicine reorder schedule 466 to make reference to a reorder date 476 that may be highlighted.

Referring now to FIG. 4B, the medicine reorder schedule 466 may include nonprescription drug information 478, which may include, but is not limited to, information regarding the non-prescription name 480, quantity 386, daily dose 396, current date 472, preferred store name 482, brand 484, preferred store phone number 486, and quantity on hand 394. In addition, a monthly calendar 474 may be included in the medicine reorder schedule 466 to make reference to a repurchase date 488 that may be highlighted.

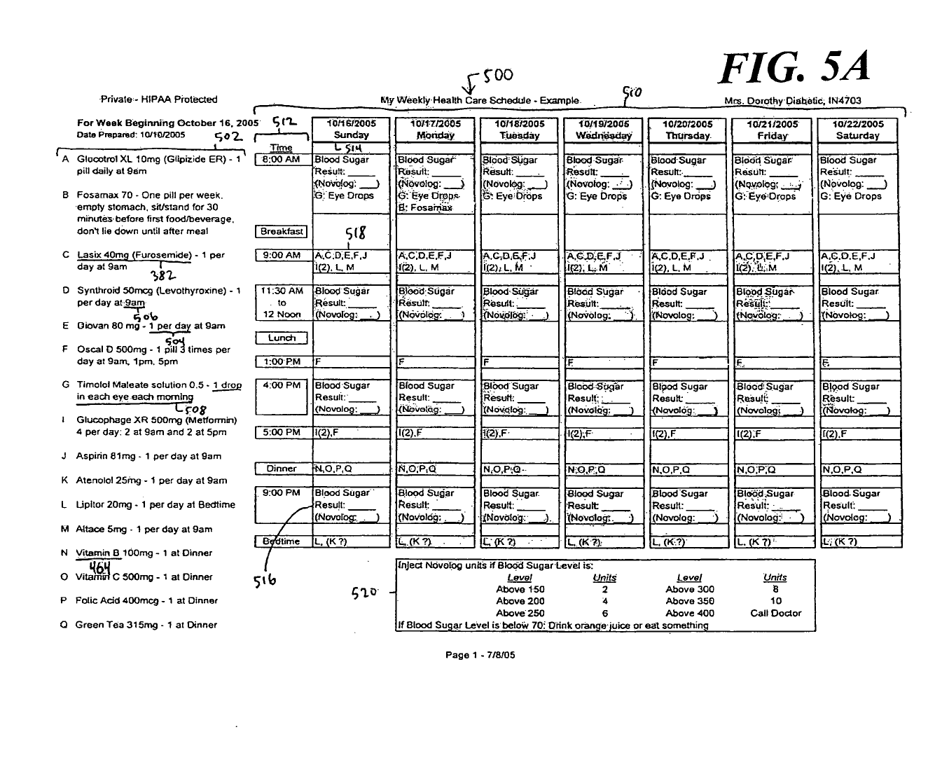

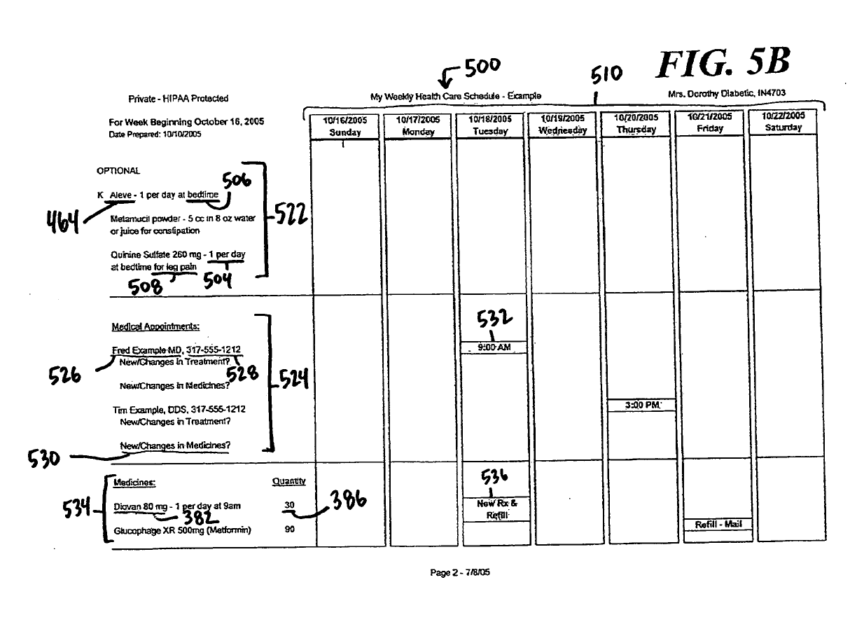

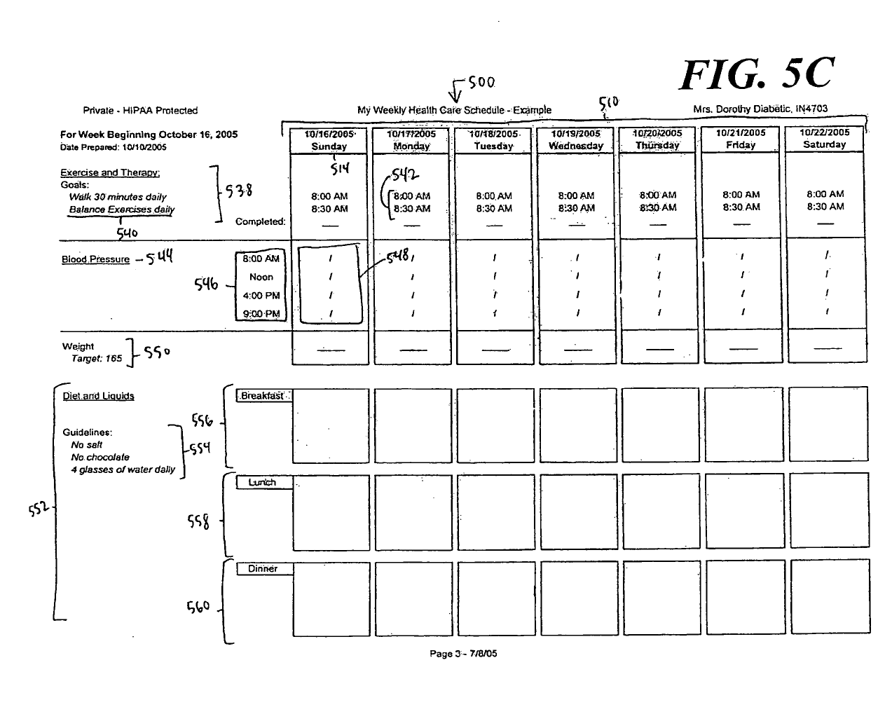

Referring now to FIG. 5A, an embodiment of a Weekly Health Care Schedule 500 is provided. The Weekly Health Care Schedule 500 may include, a list of medications 502, which may include, but is not limited to, information regarding the prescription name 382, the non-prescription name 464, frequency of daily dose 504, time of dose 506, and specific dose parameters 508. The Weekly Health Care Schedule 500 may be referred to as a “pill box,” as it may demonstrate the prescription and non-prescription medicines a Member 132 is taking. The Weekly Health Care Schedule 500 may also be generated and mailed and/or e-mailed to a Member 132. The Weekly Health Care Schedule 500 may be provided to a Member 132 to allow a Member 132 to bring the Weekly Health Care Schedule 500 to a physician during a visit. In addition, the Weekly Health Care Schedule 500 may include a weekly calendar 510, which may include, but is not limited to, information regarding a time of day 152, a day of a week 514, a blood sugar test 516, and a list of medicines to take at a specific time 518. The Weekly Health Care Schedule 500 may also include blood sugar instructions 520 to a Member 132 to assist a Member 132 with interpreting the results of a blood sugar test 516.

Referring now to FIG. 5B, the Weekly Health Care Schedule 500 may also include information regarding a list of optional medications 522, which may include, but is not limited to, information regarding the non-prescription name 464, frequency of daily dose 504, time of dose 506, and specific dose parameters 508. In addition, the Weekly Health Care Schedule 500 may include information regarding medical appointments 524, which may include, but is not limited to, the name of a provider physician 526, provider physician phone number 528, a provider physician question 530, and the appointment time 532 on the weekly calendar 510, which may include, but is not limited to, information regarding the target weight 550 of a Member 132 and information regarding diet and liquids 552, which may include, but is not limited to information regarding dietary guidelines 554, breakfast narrative 556, lunch narrative 558, and dinner narrative 560.

Referring now to FIG. 5C, the Weekly Health Care Schedule 500 may also include information regarding exercise and therapy 538, which may include, but is not limited to, information regarding a specific exercise 540 and the time to perform a specific exercise 542 on the weekly calendar 510 on the day of the week 514. In addition, the Weekly Health Care Schedule 500 may include information regarding blood pressure 544, which may include the blood pressure times 546 and blood pressure readings 548. The Weekly Health Care Schedule 500 may also include information regarding medicine refills 534, which may include, but is not limited to, the prescription name 382, quantity 386, and a refill date 536.

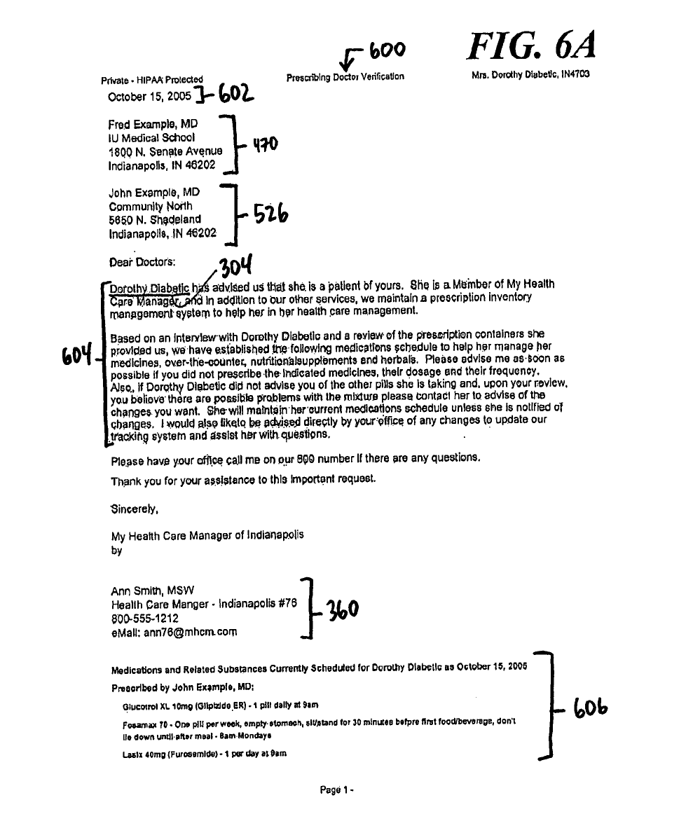

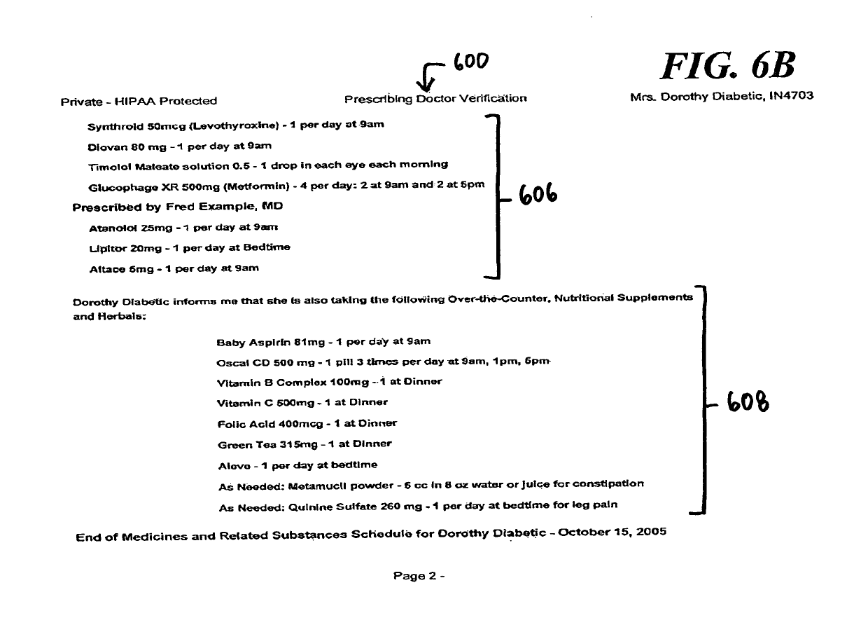

Referring now to FIG. 6A, an embodiment of a prescribing doctor verification letter 600 is provided. The prescribing doctor verification letter 600 may include, but is not limited to, information regarding a letter date 602, a prescribing physician 470, a provider physician 526, the full name 304 of a Member 132, a narrative 604 regarding the general medical status of a Member 132, contact information for a health care manager 360, a prescription medication list 606 for a Member 132 (from FIG. 6A to FIG. 6B), and a non-prescription list 608 for a Member 132 (as referenced in FIG. 6B). The prescribing doctor verification letter 600 may serve the purpose of confirming whether or not a Member 132 is prescribed the appropriate medications, is taking the appropriate medications (prescription and non-prescription), and/or whether or not there may be potential interactions between medications.

Referring back to FIG. 1, the information obtained by a Member Visit from Member Services 10 may be referenced by a Multidimensional Screening Assessment 24 and a Member Service Process 26. The Multidimensional Screening Assessment 24 may be an upfront assessment or a periodic assessment, and may include, but is not limited to, assessments regarding home safety, Member 132 depression, and/or a Member's 132 social support network.

The Multidimensional Screening Assessment 24 may also address a number of categories focusing on geriatric syndromes, dimensions of health, and dimensions affecting health. These dimensions may include, but are not limited to, a Member's 132 demographic information, including but not limited to, information regarding a Member's 132 current living and marital status, work/volunteer history, and accessibility to bathrooms, bedrooms, and laundry facilities. Additional dimensions of the Multidimensional Screening Assessment 24 may include information regarding a Member's 132 family (to identify living and deceased family members and family health history), a Member's 132 social support (with friends and family, including the levels of available support, communication techniques, and the level of a Member's engagement in social activities), and a Member's 132 representatives and key contacts. Additional dimensions of the Multidimensional Screening Assessment 24 may include, but are not limited to, financial, legal, and insurance information.

Additional dimensions of the Multidimensional Screening Assessment 24 are also provided, including, but not limited to, a spiritual dimension (to acknowledge a Member's 132 perception of his or her spiritual needs and level of comfort and peace with the Member's 132 current health status), a support services dimension (to identify multiple services providers and assess the level of communication between a Member 132 and those services providers), a caregiver support dimension (to recognize the level of stress and needs of one or more caregivers), and a physical health dimension (to address the Member's past medical history and current health status, and to capture information of a Member's 132 chronic illnesses, pain, incontinence, weight loss and/or gain, nutritional status and sleep habits). The Multidimensional Screening Assessment 24 may also include, but is not limited to, dimensions regarding a Member's 132 functional health status (to capture a Member's perception of and satisfaction with his/her health status while assessing a Member's 132 physical functional status including activities of daily living, balance, ambulation, assistive devices, and sensory status), a Member's 132 emotional/psychological status (to assess the cognitive, emotional and behavioral status of a Member 132, including screenings for cognitive impairment, anxiety, depressive symptoms, and substance abuse), and a Member's 132 medication history (to identify multiple providers, pharmacies, and allergies, as well as polypharmacy and medication administrative needs). The Multidimensional Screening Assessment 24 may further include, but is not limited to, dimensions regarding a Member's 132 home/residential environment and safety (to provide a visual assessment of the Members 132 general environment, addressing fall risks, elder abuse, disaster plans, lire/burn prevention, crime/injury prevention, and the associated communication system(s) and support network(s)), health prevention (to address whether or not a Member 132 is following preventative recommendations and attending health screening activities), and wellness (to assess a Member's understanding of activities that promote improved health status, as well as wellness classes, tobacco use, and/or intellectual stimulation).

The Multidimensional Screening Assessment 24 may serve to analyze the initial patient information obtained from a Member Visit and to determine an initial assessment of a Member 132. The Member Service Process 26 may provide specific procedures to providers of service to a Member 132. The Member Service Process 26 may, in turn, generate a Periodic Reassessment 28 that may be referenced by the Multidimensional Screening Assessment 24.

A Service Operational & Decision Support 30 may also reference information by the Member Service Process 26, which may, in turn, reference information back to the Service Operational & Decision Support 30. The Service Operational & Decision Support 30 may be computer-automated, may provide specific analytical service support information to the Member Service Process, and may enforce specific methodologies regarding the collection and reporting of a Member's 132 information. Information from the Multidimensional Screening Assessment 24 may generate Assessment Results 32 that may be referenced by a Member Database 34. The Member Database 34 may function as a central repository of information regarding the Members 132 receiving services. The Service Operational & Decision Support 30 and the Member Database 34 may generate and/or share Health Updates 36 with one another.

The Member Database 34 may refer information to Predictive Data Mining 37, which may, in turn, refer information for Process Improvement Decisions 38 that may refer information back to the Member Service Process 26 and/or may generate Process Improvements 40 that may be referred to the Service Operational & Decision Support 30. The Predictive Data Mining 37 may function to review and interpret a Member's 132 data to predict particular outcomes regarding the condition of a Member 132. For example, the Predictive Data Mining 37 may analyze information regarding the relative safety of a Member's 132 home, like, for example, the presence or absence of support bars in a shower area, and coupled with information about a Member's 132 general well-being, like, for example, bone density information, the Predictive Data Mining 37 may predict a likelihood that a Member 132 may suffer from a bone fracture. The Member Database 34 may also refer information to Advance Quality Analytics 42, which may, in turn, refer information for Process Improvement Decisions 38 that may refer information back to the Member Service Process 26 and/or may generate Process Improvements 40 that may be referred to the Service Operational & Decision Support 30, and/or the Advance Quality Analytics 42 may, in turn, refer information for Quality Metrics Decisions 44 that may generate Quality Improvements & Refined Metrics 46 that may be referred to the Member Service Process 26. In addition, the Member Database 34 may refer information to a Member/Family Portal 48, that via Secure Access 50 may refer information to and from a Internet 52. The Member Database 34 may also refer information to a Member Decision Support 54 that may, in turn, refer information to prepare several records and/or tools, including a Health Care Record 300 (referred to as “Personal Health Care Record” on FIG. 1), a Weekly Health Care Schedule 500 (referred to as a “Personal Weekly Schedule” on FIG. 1), a Member Ready Reference Card 56, a Medication Record 58, a Physician Appointment Planner 60, and Important Names and Numbers 62.

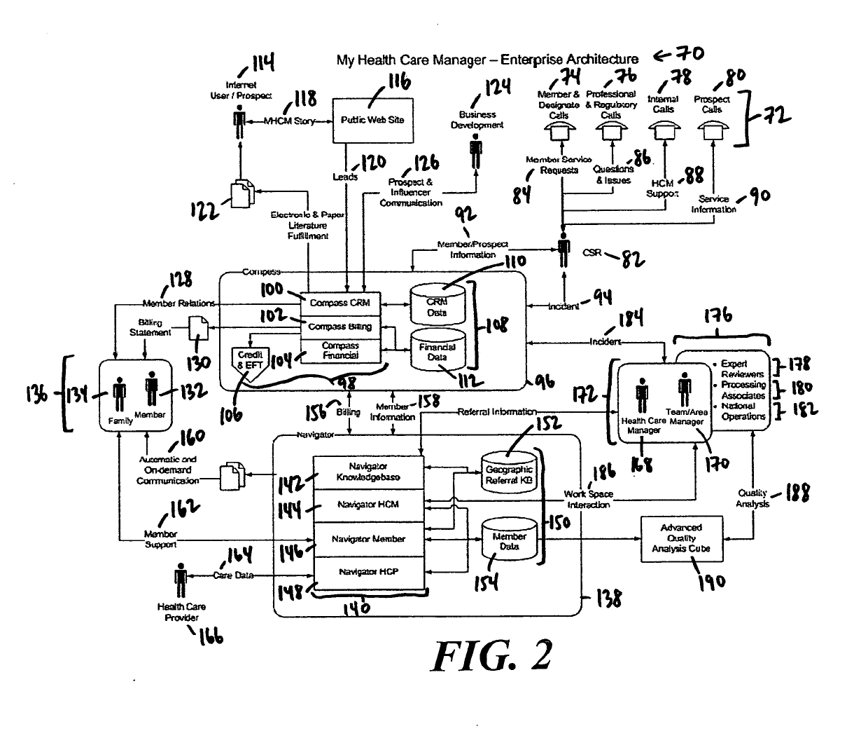

Referring now to FIG. 2, an embodiment of an enterprise architecture 70 is provided. The enterprise architecture 70 may be referred to as a control system, wherein information is obtained and processed, allowing for any number of reports, including prescription refills, renewals, and rescheduling of activities, to be prepared. The enterprise architecture 70 may include, but is not limited to, at least one type of call 72, which may include, but is not limited to, Member and designate calls 74, professional and regulatory calls 76, internal calls 78, and prospect calls 80. The at least one type of call 72 to or from a customer service representative 82 may result in Member service requests 84, questions and answers 86, health care management support 88, and service information 90. The customer service representative 82 may then relay Member/prospect information 92 and/or first incident information 94 to a first database 96. The first database 96, labeled as “Compass” on FIG. 2, may include one or more first database modules 98, including, but not limited to, a customer relationship management module 100, a billing module 102, a financial module 104, and a credit & electronic funds transfer module 106. Information from one or more first database modules 98 may be shared, distributed to, or retrieved from at least one first database data repository 108, which may include, but is not limited to, a CRM data repository 11 (and/or a financial data repository 112.

Additional information may be shared with the first database 96. An internet user 114 and a public web site 116 may exchange health care story information 118, which may, in turn, provide leads 120 to the first database 96. The first database 96 may then, in turn, provide electronic & paper literature 122 back to the internet user 114. A business development user 124 may also exchange a prospect & influencer communication 126 with the first database 96.

In addition, the first database 96 may provide Member relations information 128 and a billing statement 130 to a Member 132 and/or a Member's 132 family member 134 (a Member 132 and the Member's 132 family member 134 collectively referred to as a Member recipient 136).

In addition to the foregoing, a second database 138, labeled as “Navigator” on FIG. 2, may include one or more second database modules 140, including, but not limited to, a knowledgebase module 142, a health care manager module 144, a Member module 146, and a health care provider module 148. Information from one or more second database modules 140 may be shared, distributed to, or retrieved from at least one second database data repository 150, which may include, but is not limited to, a geographic referral knowledgebase data repository 152 and/or a Member data repository 154. The first database 96 and the second database 138 may then exchange billing information 156 and/or Member information 158. The second database 138 may provide automatic and on-demand communication information 160 to the Member recipient 136, and may also exchange Member support information 162 with the Member recipient 136. In addition, the second database 138 may exchange care data 164 with a health care provider 166.

The enterprise architecture 70 ma also include a health care manager 168 and a team/area manager 170, collectively referred to as system managers 172. The system managers 172 may relate to secondary managers 176, which may include expert reviewers 178, processing associates 180, and national operators 182. The system managers 172 and secondary managers 176 may exchange second incident information 184 with the first database 96. In addition the system managers 172 and secondary managers 176 may exchange work space interaction information 186 with the second database 138, and the system managers 172 and secondary managers 176 may also exchange quality analysis information 188 with an advanced quality analysis cube 190. The Member data repository 154 may exchange information with the Member module 146 of the second database 138, which may then, in turn, provide information to the advanced quality analysis cube 190.

Regarding the foregoing, it can be appreciated that the first database 96 and the second database 138 may also be one unitary database. It can also be appreciated that the one or more first database modules 98 and the one or more second database modules 140 may also be interchangeable. In addition, it can be appreciated that at least one first database data repository 108 and the at least one second database data repository 150 may also be interchangeable.

It can also be appreciated that the particular configuration of hardware and software illustrated in FIGS. 1 and 2 are only a single embodiment of the system of the present disclosure. Various configuration-s of hardware and software may be used to achieve the functionality demonstrated in connection with the system. Such variations are contemplated to be within the scope of the disclosed system.

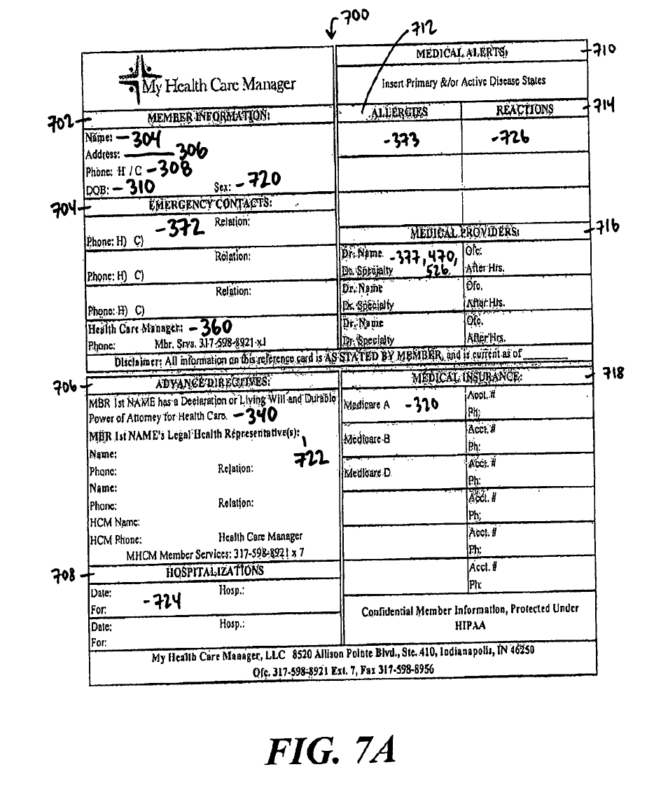

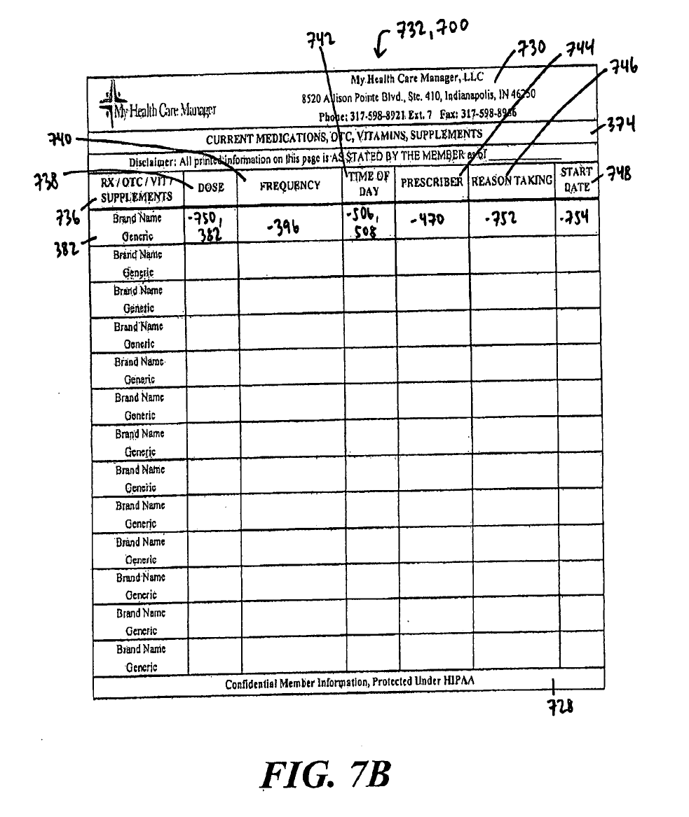

In addition to the foregoing, several additional records may be produced by the system of the present application. For example, and referring now to FIG. 7A, an embodiment of a front of a ready reference card 700 is provided. The ready reference card 700 may include, but is not limited to, information under the following headings: “MEMBER INFORMATION” 702, “EMERGENCY CONTACTS” 704, “ADVANCE DIRECTIVES” 706, “HOSPITALIZATIONS” 708, “MEDICAL ALERTS” 710 (which may include, but is not limited to, information under the headings of “ALLERGIES” 712 and “REACTIONS” 714), “MEDICAL PROVIDERS” 716, and “MEDICAL INSURANCE” 718. The MEMBER INFORMATION heading 702 may include, but is not limited to, a Member's 132 contact information 302, full name 304, address 306, home phone number 308, e-mail address 310, and gender 720. The EMERGENCY CONTACTS heading 704 may include, but is not limited to, information regarding one or more emergency contacts 372 and contact information for a health care manager 360. The ADVANCE DIRECTIVES heading 706; may include, but is not limited to information on a Member's 132 advance directives 340 and a Member's 132 legal health representative 722. The HOSPITALIZATIONS heading 708 may include, but is not limited to, hospitalization information 724 relating to the date(s), hospital(s) attended, and the reason(s) for the hospitalization(s). The MEDICAL ALERTS heading 710 may include, but is not limited to, information pertaining to specific diseases; and/or other medical conditions that pertain to a Member 132. The ALLERGIES heading 712 may include, but is not limited to, information pertaining to a Member's 132 allergies 373. The REACTIONS heading 714 may include, but is not limited to, the reactions 726 that may result from one or more of a Member's 132 allergies 373 as shown in the ALLERGIES heading 712. The MEDICAL PROVIDERS heading 716 may include, but is not limited to, a Member's 132 medical porovider(s), including at least one prescribing physician 470, provider physician 526, and/or caregiver/doctor 377, including the contact information for the listed medical provider(s). The MEDICAL INSURANCE heading 718 may include, but is not limited to, a Member's 132 insurance information 320. The ready reference card 700 may also include a confidentiality statement 728 and general contact information 730 for the organization that prepared the ready reference card 700.

Referring flow to FIG. 7B, an embodiment of a back (or second page) 732 of a ready reference card 700 is provided, which may include, but is not: limited to, general contact information 730 for the organization that prepared the ready reference card 700, a confidentiality statement 728, and information tinder the heading “CURRENT MEDICATIONS, OTC [OVER-THE-COUNTER], VITAMINS, SUPPLEMENTS” 734, which may include, but is not limited to, information under the subheadings of “RN [PRESCRIPTION], OTC, VIT [VITAMINS], SUPPLEMENTS” 736, “DOSE” 738, “FREQUENCY” 740, “TIME OF DAY” 742, “PRESCRIBFIR” 744, “REASON TAKING” 746, AND “START DATE” 748. The RX, OTC, VIT, SUPPLEMENTS subheading 736 may include, but is not limited to, the brand and/or generic prescription name(s) 382 of the prescription, over-the-counter medication, vitamin, supplement, and the like (collectively and generally referred to as a “medication”), that a Member 132 is taking. The DOSE subheading 738 may include the dose (amount of active ingredient) 750 of the prescription, name(s) 382, and such information may be obtained from the prescription name(s) 382 or an entry of the dose 750 information. The FREQUENCY subheading 740 may include, but is not limited to, information on the daily dose 396 and specific dose parameters 508. The TIME OF DAY subheading 742 may include time of dose 506 information and specific dose parameters 508. The PRESCRIBER subheading 744 may include prescribing physician 470 information. The REASON TAKING subheading 746 may include, but is not limited to, one or more reasons 752 why a Member 132 is taking a particular medication. The START DATE subheading 748 may include the date 754 a Member 132 began taking a particular medication.

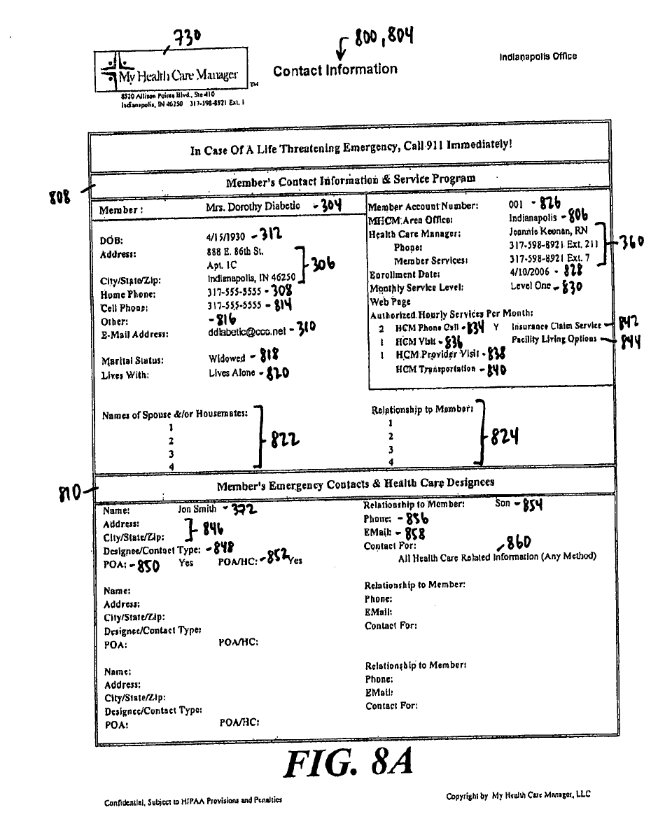

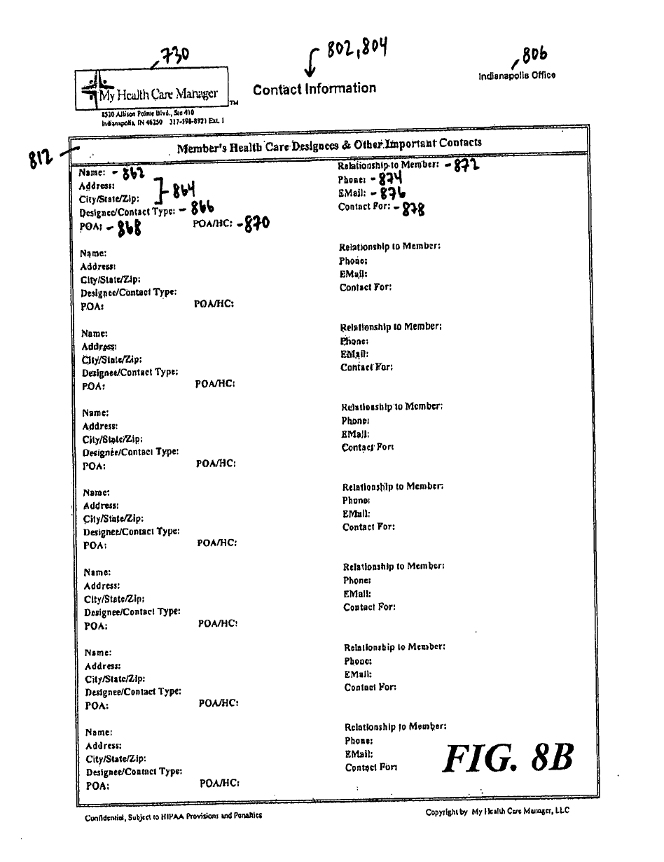

In addition, the following additional records may be produced by the system of the present application. FIGS. 8A and 8B show an embodiment of a first page 800 and a second page 802, respectively, of a Contact Information Record 804 of the system of the present application. The Contact Information Record 804 may include, but is not limited to, information under the following headings: “Member's Contact Information & Service Program” 808, “Member's Emergency Contacts & Health Care Designees” 810, and “Member's Health Care Designees & Other Important Contacts” 812. The Member's Contact: Information & Service Program heading 808 includes a Member's 132 contact information 302 including, but is not limited to a Member's 132 full name 304, date of birth 312, address 306, home phone number 308, cell phone number 814, e-mail address 310, marital status 818, and other contact information 816. Information on other people 820 who may live with a Member 132 may also be included, comprising their name(s) 822 and relationship(s) 824 to a Member 132. The Member's Contact Information & Service Program heading 808 may also include information pertaining to a Member's 132 account number 826, the service provider's office location information 806, contact information for a health care manager 360, a Member's 132 enrollment date 828 and service level 830, and specific service level details 832, including, but not limited to, allotments for the number of phone calls 834, general visits 836 and provider visits 838, transportation options 840, insurance claim services 842, and facility living options 844.

The Member's Emergency Contacts & Health Care Designees heading 810 of the Contact Information Record 804 may include one or more emergency contacts 372 for a Member 132, including, but not limited to, an emergency contact address 846, designee/contact type 848, general power of attorney (POA) status 850, health care power of attorney (P OA/HC) status 852, relationship to Member 854, phone number 856, e-mail address 858, and emergency contact circumstances 860.

The Member's Health Care Designees & Other Important Contacts heading 812 of the Contact Information Record 804 (shown on FIG. 8B) may include one or more health care designees 862 for a Member 132, including, but not limited to, a health care designee address 864, designee/contact type 866, general power of attorney (POA) status 868, health care power of attorney (POA/HC) status 870, relationship to Member 872, phone number 874, e-mail address 876, and emergency contact circumstances 878.

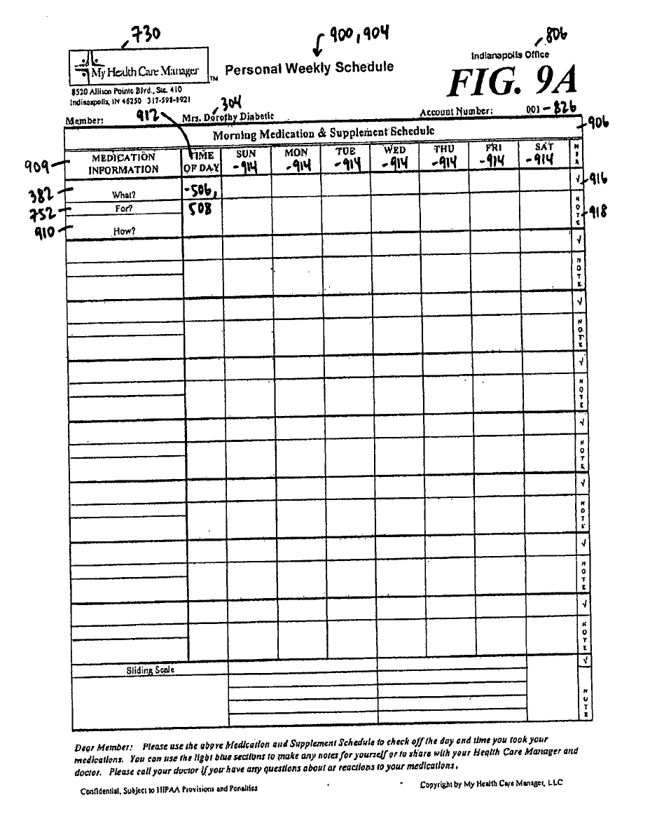

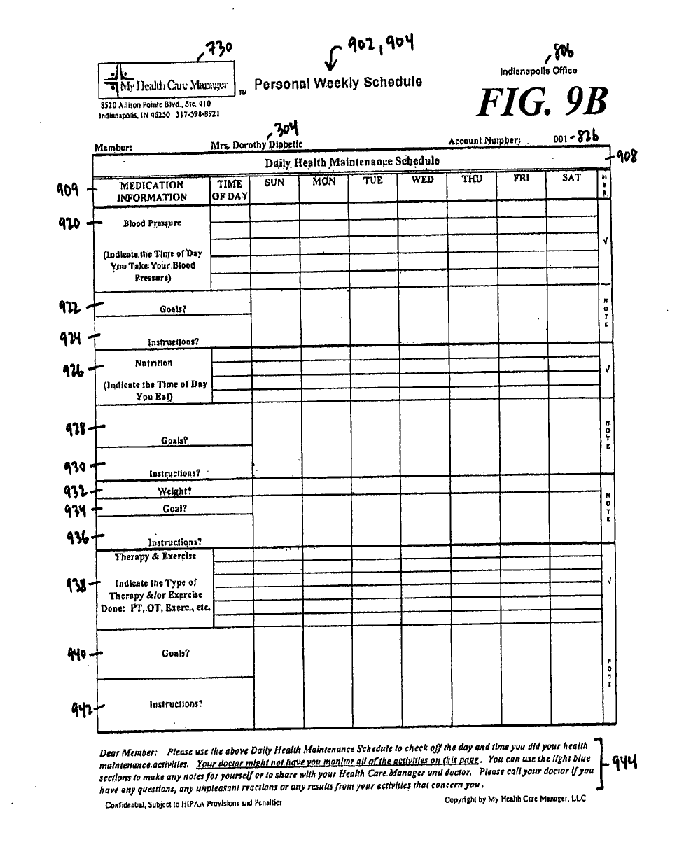

FIGS. 9A and 9B show an embodiment of a first page 900 and a second page 9023 respectively, of a Personal Weekly Schedule 904. The Personal Weekly Schedule 904 may include, but is not limited to information under the headings “Morning Medication & Supplement Schedule” 906 and “Daily Health Maintenance Schedule” 908. The Morning Medication & Supplement Schedule heading 906 may include a “Medication Information” subheading 909 to show the medication being taken (prescription name 382, shown as the “What?” on FIG. 9A), one or more reasons 752 why a Member 132 is taking a particular medication (the “For?” on FIG. 9A), and a method of taking a medication 910 (the “How?” on FIG. 9A). A “Time of Day” subheadings 912 may also be provided on the Personal Weekly Schedule 904, including, but not limited to, information on the time of dose 506 and specific dose parameters 508. Days of the week subheadings 914 may also be provided, and a Member 132 may indicate when he or she has taken a medication (indicated by the boxes with a check-mark identifier 916). A Member 132 may also enter one or more notes (as indicated by the boxes with a note identifier 918) relating to a particular dose 750 of medication.

FIG. 9B shows an embodiment of a second page 902 of a Personal Weekly Schedule 904. The Personal Weekly Schedule 904 may include, but is not limited to, information under the Daily Health Maintenance Schedule heading 908, and may also include a number of additional informational topics, including Blood Pressure 920 whereby a Member 132 may indicate whether or not a blood pressure reading was taken and/or the results of said reading(s), and which may comprise Blood Pressure Coals 922 information, including, but not limited to, a target blood pressure or a target blood pressure range for a Member 132, and Blood Pressure Instructions 924 information for a Member 132 to follow when taking his or her blood pressure. The Daily Health Maintenance Schedule heading 908 may also include the inform-national topic of Nutrition 926 whereby a Member 132 may indicate the time of day he or she eats a meal, and which may comprise Nutrition Goals 928 information for a daily and/or weekly intake of food, and Nutrition Instructions 930 information for a Member 132 to follow when following a particular diet. The Daily Health Maintenance Schedule heading 908 may also include the informational topic of Weight 932 whereby a Member 132 may indicate his or her weight as taken during the week, and which may comprise Weight Goals 934 information comprising a target weight or weight range, and Weight Instructions 936 information for a Member 132 to follow when taking his or her weight. The Daily Health Maintenance Schedule heading 908 may further include the informational topic of Therapy & Exercise 938 whereby a Member 132 may indicate the types of therapy and/or exercise performed during the week, and which may include Therapy & Exercise Goals 940 information comprising therapies and/or exercises a Member 132 aims to perform during a given time period, and Therapy & Exercise Instructions 942 information for a Member 132 to follow when performing said therapies and/or exercises. In addition to the foregoing, the Personal Weekly Schedule 904 may include Personal Weekly Schedule instruction 944 for a Member 132 to follow when entering information into the Personal Weekly Schedule 904.

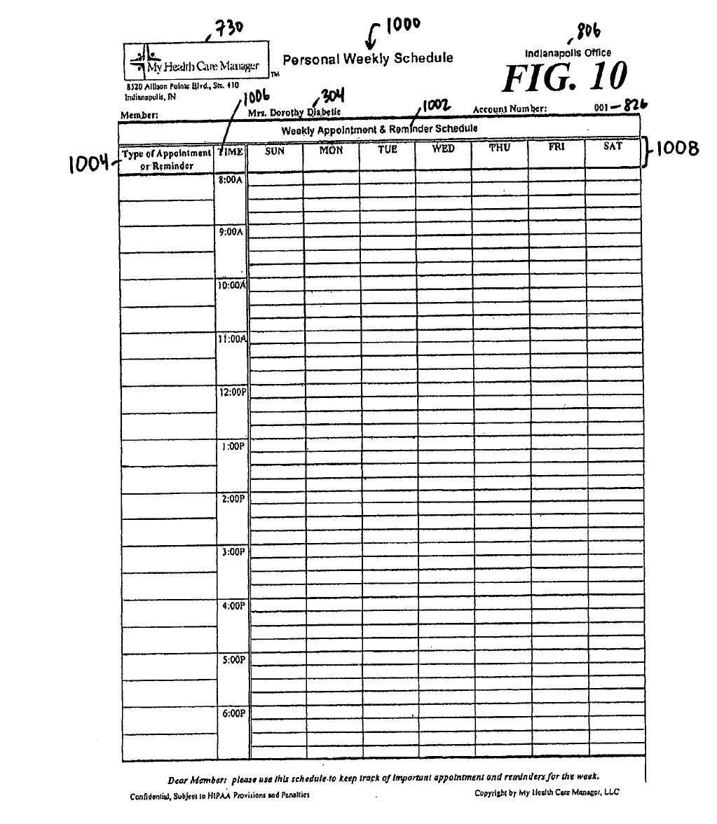

FIG. 10 shows an embodiment of a Personal Weekly Schedule for appointments or TO reminders 1000 of the system of the present application. The Personal Weekly Schedule for appointments or reminders 1000 may include a “Weekly Appointment & Reminder Schedule” heading 1002, and may include subheadings of “Type of Appointment or Reminder” 1004 for a Member 132 to list the particular appointment(s) and/or reminder(s), “Time” (of the appointment or reminder) 1006, and days of the week 1008 pertaining to appointment(s) and/or reminder(s).

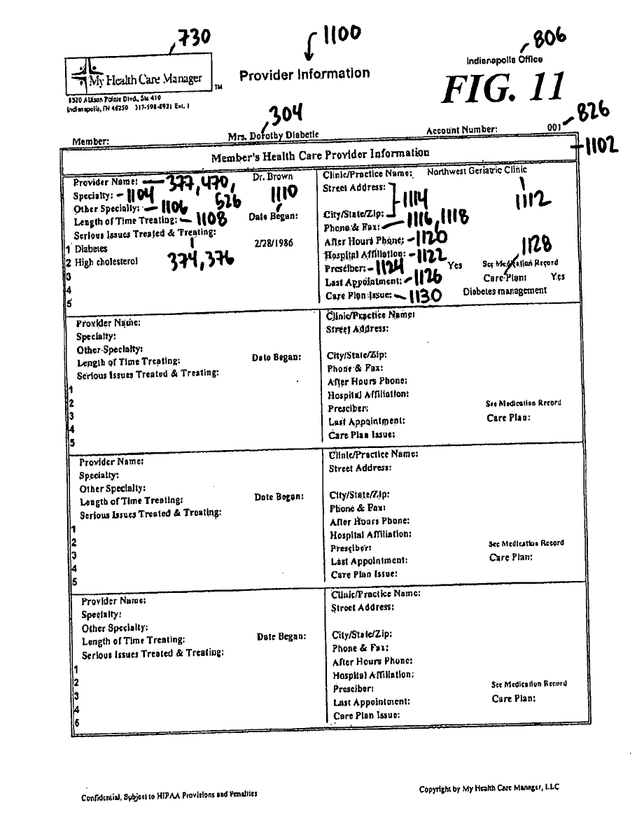

FIG. 11 shows an embodiment of a Provider Information record 1100 of the present disclosure. The Provider Information record 1100 may include a “Member's Health Care Provider Information” heading 1102, which may include, but is not limited to, a health care provider's name (for the at least one prescribing physician 470, provider physician 526, and/or caregiver/doctor 377), a first physician specialty 1104, one or more additional physician specialties 1106, duration of physician treatment 1108 of a Member 132, date of first physician treatment 1110 of a Member 132, and the description(s) 376 of the at least one medical issue(s) 374. The Provider Information record 1100 may also include, but is not limited to, the clinic/practice name 1112, address 1114, phone number 1116, fax number 1118, after hours phone number 1120, hospital affiliation 1122, physician prescriber confirmation 1124, date of last Member appointment 1126, health care plan confirmation 1128, and health care plan issue information 1130. Multiple entries under the “Member's Health Care Provider Information” heading 102 may be included to reference more than one prescribing physician 470, provider physician 526, and/or caregiver/doctor 377.

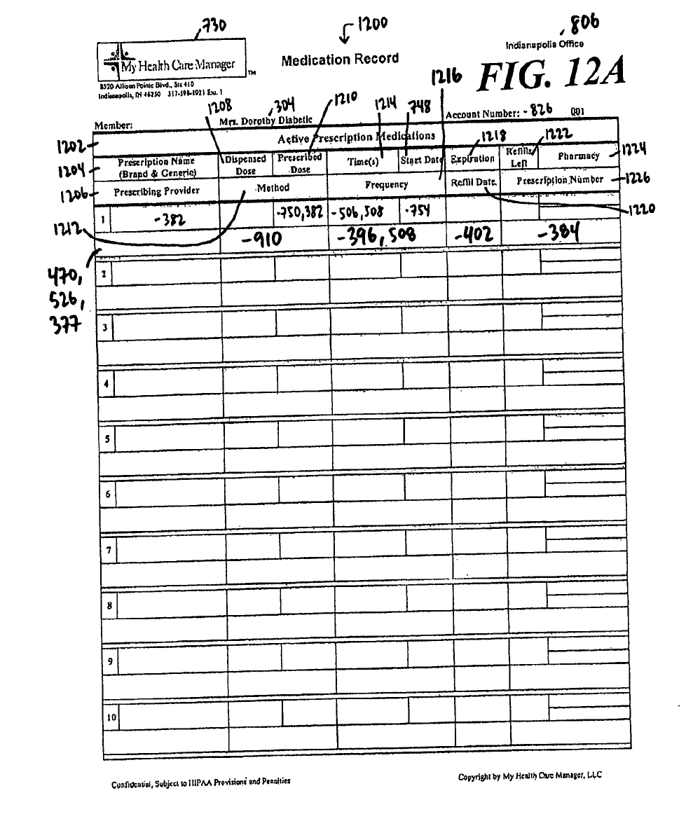

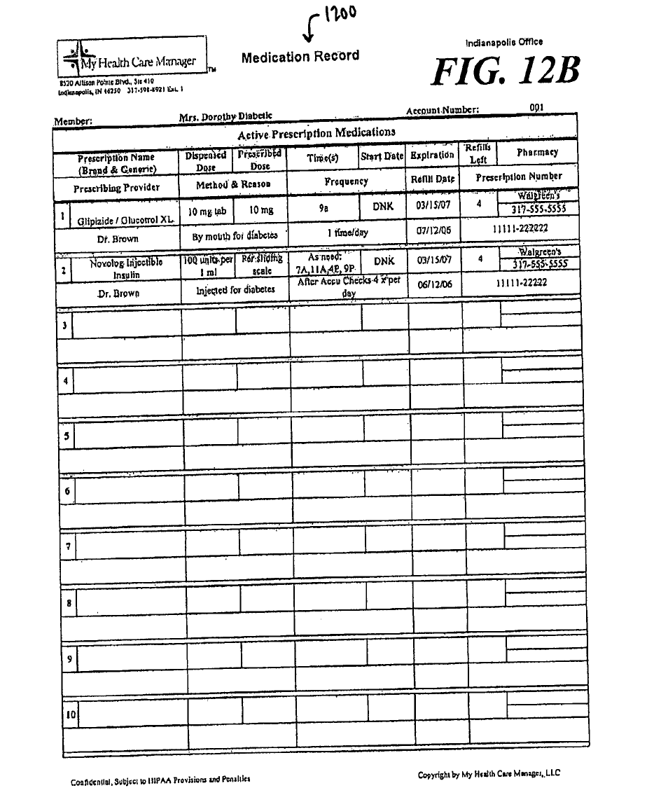

FIGS. 12A and 12B show an embodiment of a Medication Record for prescriptions 1200 (FIG. 12A blank and FIG. 12B including sample data) of the present disclosure. The Medication Record for prescriptions 1200 may include an “Active Prescription Medications” heading 1202, which may include, but is not limited to, information under the subheadings of “Prescription Name (Brand & Generic)” 1204, “Prescribing Provider” 1206, “Dispensed Dose” 1208, “Prescribed Dose” 1210, “Method” 1212, “Time(s)” 1214, “Start Date” 748, “Frequency” 1216, “Expiration” 1218, “Refill Date” 1220, “Refills Left” 1222, “Pharmacy” 1224, and “Prescription Number” 1226. The Prescription Name (Brand & Generic) subheading 1204 may include, but is not limited to, the brand and/or generics prescription name(s) 382 of the prescription that a Member 132 is taking. The Prescribing Provider subheading 1206 may include information pertaining to the prescribing physician 470. The Dispensed Dose subheading 1208 may include information pertaining to the dose of the prescription a Member 132′ was actually dispensed. The Prescribed Dose subheading 1210 may include, but is not limited to the dose (amount of active ingredient) 750 of the prescription name(s) 382, and such information may be obtained from the prescription name(s) 382 or an entry of the dose 750 information. The Method subheading 1212 may include, but is not limited to, information regarding the method of taking a medication 910. The Time(s) subheading 1214 may include time of dose 506 information and specific dose parameters 508. The Start Date subheading 748 may include the date 754 a Member 132 began taking a particular medication. The Frequency subheading 1216 may include, but is not limited to, information on the daily dose 396 and specific dose parameters 508. The Expiration subheading 1218 may include, but is not limited to, information per training to the expiration date of the prescription. The Refill Date subheading 1220 may include, but is not limited to, the date of a Member's 132 next refill 402. The Refills Left subheading 1222 may include the number of remaining refills 400 for a particular prescription. The Pharmacy subheading 1224 may include, but is not limited to, the name and/or contact information of the pharmacy prescribing the prescription. The Prescription Number subheading 1226 may include, but is not limited to, the prescription number 384 and/or other identifier for a particular prescription.

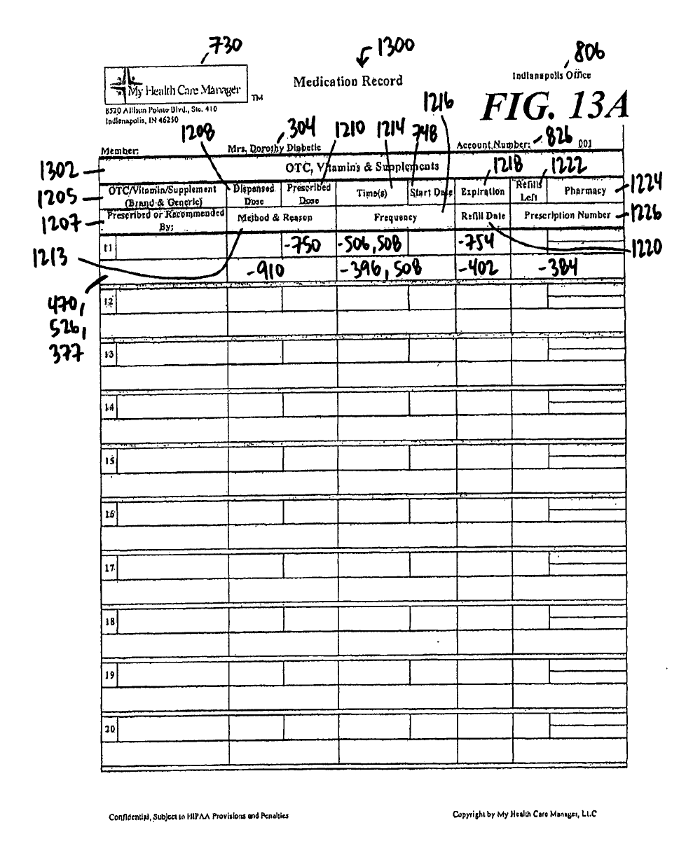

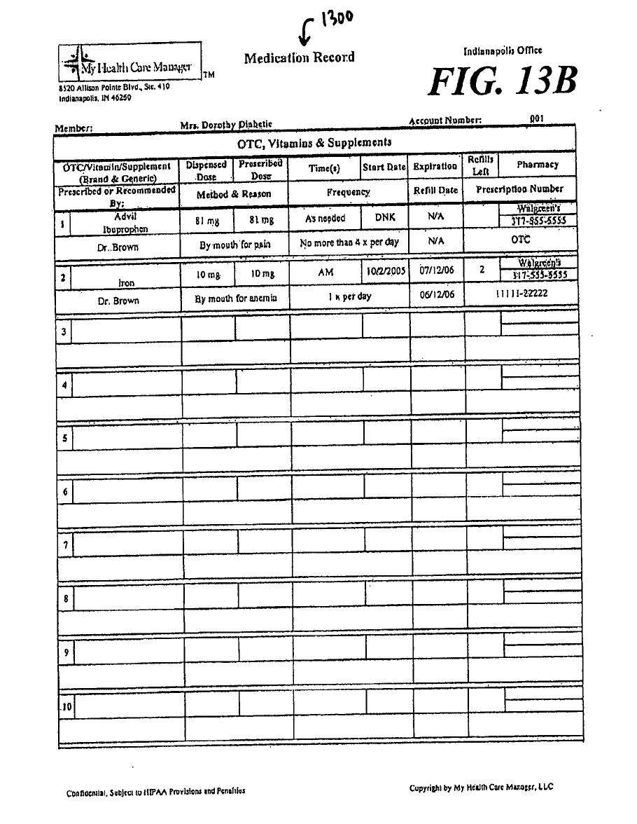

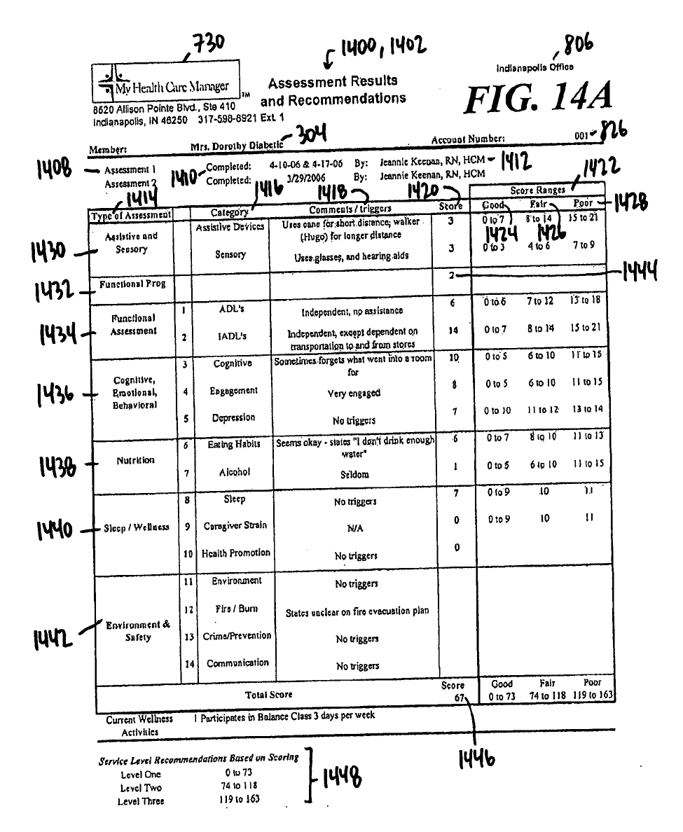

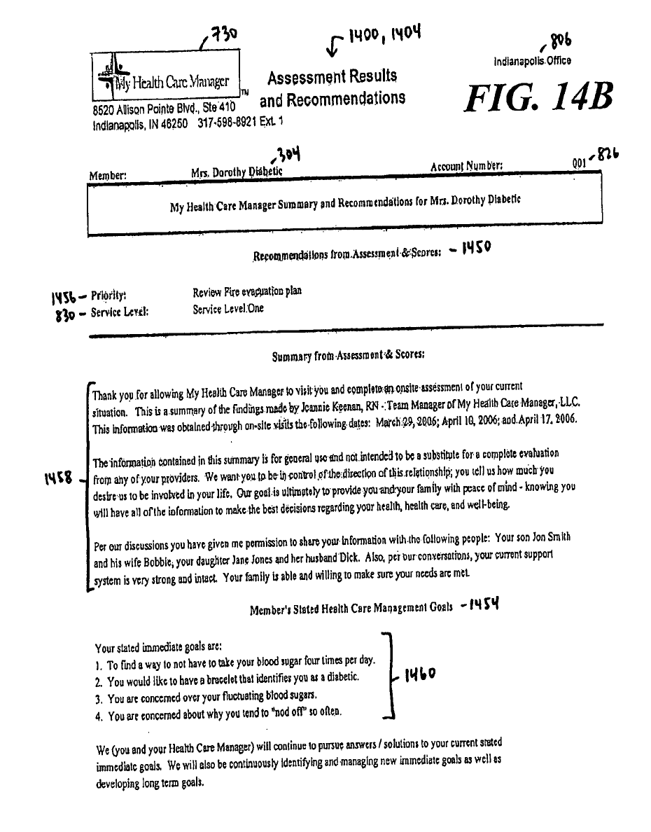

FIGS. 13A and 13B show an embodiment of a Medication Record for non-prescription medications, vitamins, and supplements 1300 (FIG. 13A blank and FIG. 13B including sample data) of the present disclosure. The Medication Record for non-prescription medications, vitamins, and supplements 1300 may include an “OTC, Vitamins & Supplements” heading 1302, which may include, but is not limited to, information under the subheadings of “OTC/Vitamin/Supplement (Brand & Generic)” 1205, “Prescribed or Recommended By” 1207, “Dispensed Dose” 1208, “Prescribed Dose” 1210, “Method & Reason” 1213, “Time(s)” 1214, “Start Date” 748, “Frequency” 1216, “Expiration” 1218, “Refill Date” 1220, “Refills Left”1222, “Pharmacy” 1224, and “Prescription Number” 1226. The OTC/Vitamin/Supplement (Brand & Generic) subheading 1205 may include, but is not limited to, the non-prescription medication(s), vitamin(s), and supplement(s) (collectively a “non-prescription medication”) that a Member 132 is taking. The Prescribed or Recommended By subheading 1207 may include, but is not limited to, the prescribing physician 470, provider physician 526, and/or caregiver/doctor 377 who prescribed and/or recommended the non-prescription medication(s), vitamin(s), and supplement(s) to a Member 132. The Dispensed Dose subheading 1208 may include information pertaining to the dose of the non-prescription medication(s), vitamin(s), and supplement(s) a M Member 132 was actually dispensed. The Prescribed Dose subheading 1210 may include, but is not limited to, the dose (amount of active ingredient) 750 of the non-prescription medication(s), vitamin(s), and supplement(s). The Method & Reason subheading 1213 may include, but is not limited to, information regarding the method of taking a medication 910. The Time(s) subheading 1214 may include time of dose 506 information and specific dose parameters 508. The Start Date subheading 748 may include the date 754 a Member 132 began taking a particular medication. The Frequency subheading 1216 may include, but is not limited to, information on the daily dose 396 and specific dose parameters 508. The Expiration subheading 1218 may include, but is not limited to, information pertaining to the expiration date of the non-prescription medication(s), vitamin(s), and supplement(s). The Refill Date subheading 1220 may include, but is not limited to, the date a Member's 132 non-prescription medication(s), vitamin(s), and supplement(s) will need to be refilled. The Refills Left subheading 1222 may include the number of refills remaining for a particular non-prescription medication, vitamin, and supplement. The Pharmacy subheading 1224 may include, but is not limited to, the name and/or contact information of the pharmacy prescribing the non-prescription medication(s), vitamin(s), and supplement(s). The Prescription Number subheading 1226 may include, but is not limited to, the number and/or other identifier for a particular non-prescription medication(s), vitamin(s), and supplement(s).

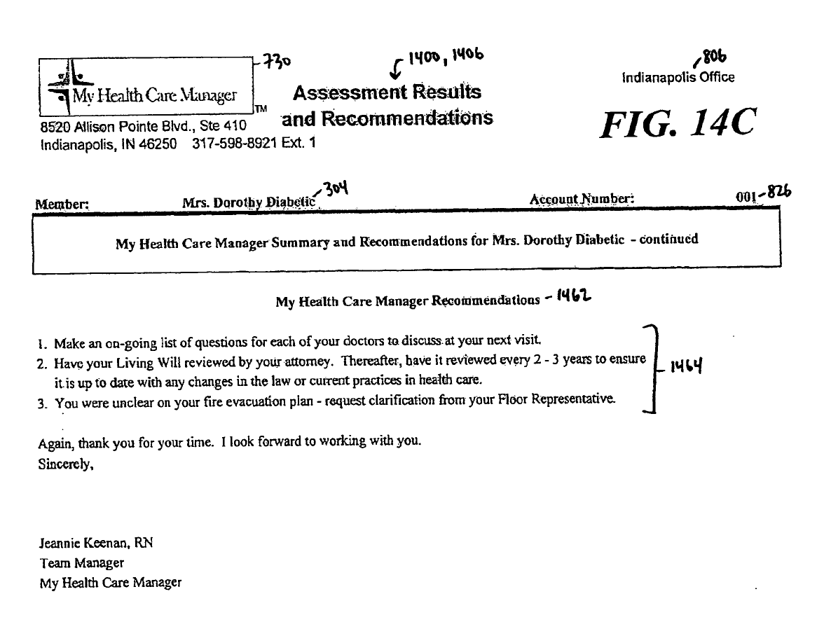

FIGS. 14A, 14B, and 14C show an embodiment of a first 1402, second 1404, and third page 1406, respectively, of an Assessment Results and Recommendations Record 1400 of the system of the present application. The Assessment Results and Recommendations Record 1400 many also identify at least one assessment number 1408, at least one assessment completion date 1410, and at least one assessment manager name 1412.

The Assessment Results and Recommendations Record 1400 may also include headings including, but not limited to, a “Type of Assessment” 1414, “Category” 1416 within a type of assessment to denote an assessment category, “Comments/triggers” 1418 pertaining to the individual categories, a “Score” 1420 to be determined based on “Score Ranges” 1422 of “Good” 1424, “Fair” 1426, and “Poor” 1428, whereby the Score Ranges 1422 may differ for each particular category of assessment. The Type of Assessment heading 1414 may include one or more assessment types, including, but not limited to, Assistive and Sensory 1430, Functional Progress 14327, Functional Assessment 1434, Cognitive, Emotional, and Behavioral 1436, Nutrition 1438, Sleep/Wellness 1440, and Environment & Safety 1442. Once an assessment has been completed, individual scores 1444 under the Score heading 1420 may be added to result in a total score 1446 for a particular assessment Based on the total score 1446 for a particular assessment, the level of service for a Member 132 may be determined based upon the scoring guidelines 1448.

FIG. 14B shows an embodiment of a second page 1404 of an Assessment Results and Recommendations Record 1400 of the system of the present application. The Assessment Results and Recommendations Record 1400 may include headings including, but not limited to, “Recommendations from Assessment & Scores” 1450, “Summary from Assessment & Scores” 1452, and “Member's Stated Health Care Management Goals” 1454, and these headings may include information based upon one or more assessments of a Member 132. Information within the Recommendations from Assessment & Scores heading 1450 may include, but is not limited to, at least one priority task 1456 to be addressed by a Member 132, and the Member's 132 current service level 830. Information within the Summary from Assessment & Scores heading 1452 may include, but is not limited to, assessment identification inform-nation 1458 showing the dates of the assessment(s) and at least one assessment manager name 1412 who performed the assessment(s). Information within the Member's Stated Health Care Management Goals heading 1454 may include at least one immediate goal 1460 for a Member 132 to consider.

FIG. 14C shows an embodiment of a third page 1406 of an Assessment Results and Recommendations Record 1400 of the system of the present application. The Assessment Results and Recommendations Record 1400 may include a heading of “My Health Care Manager Recommendations” 1462, and within that heading may include at least one recommendation 1464 provided by the health care manager 168 for the benefit of a Member 132.

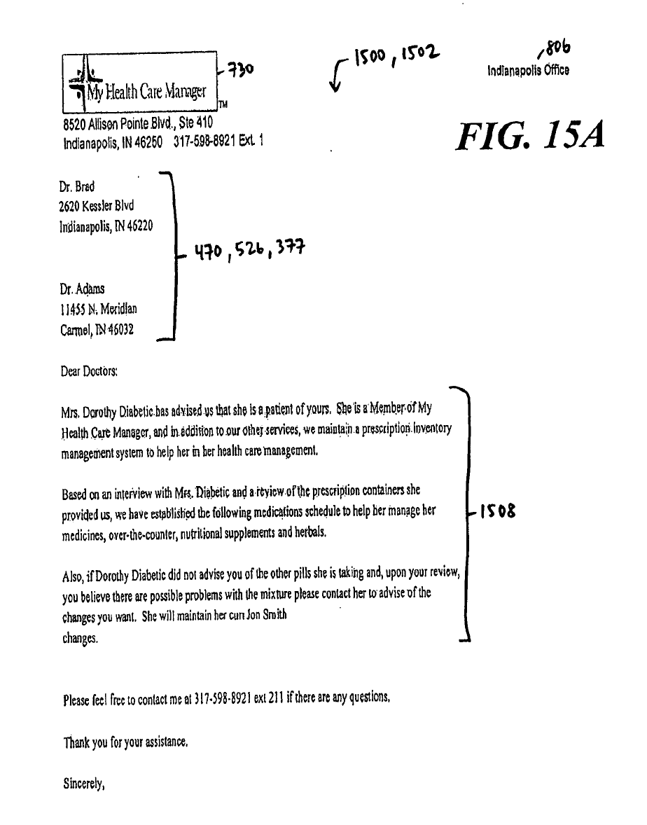

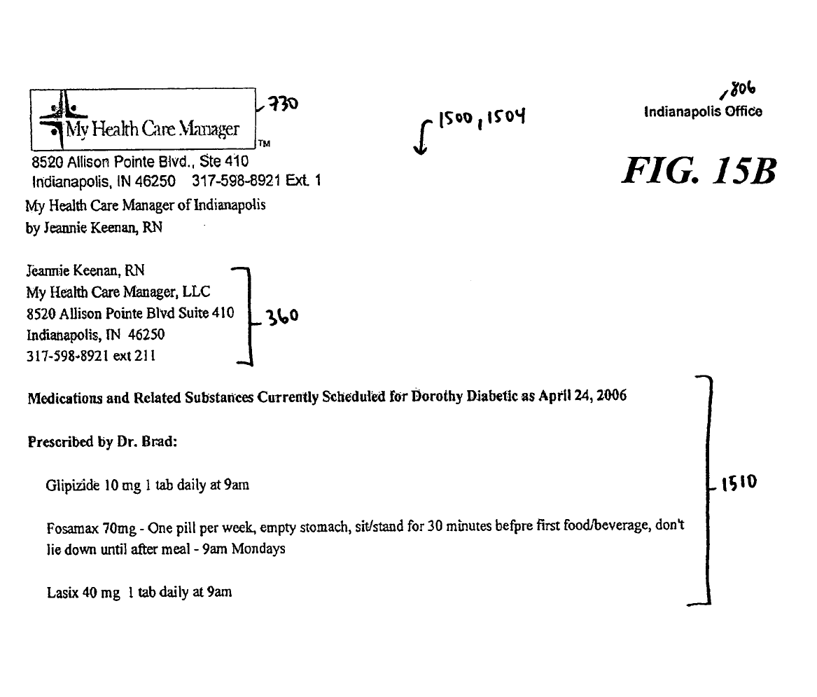

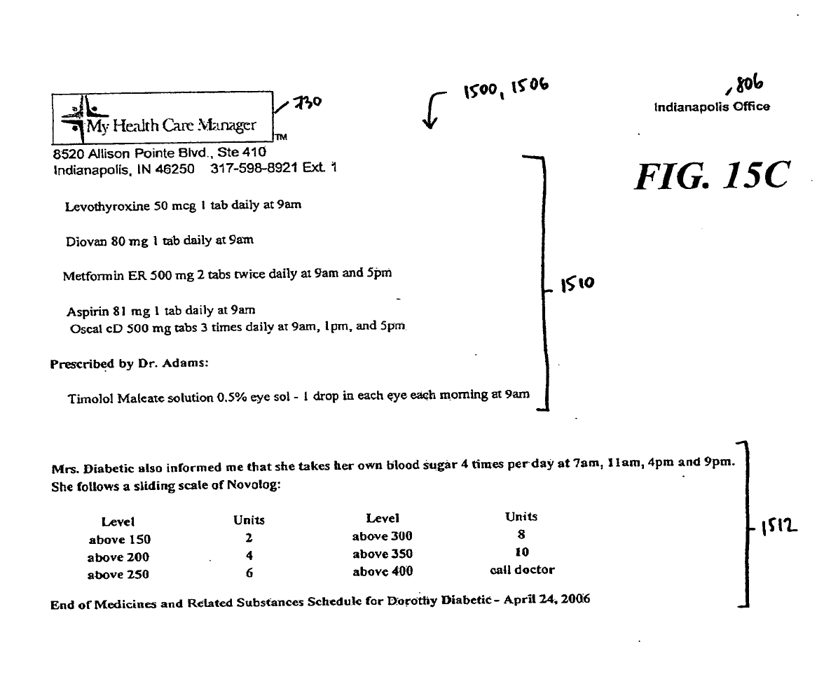

Additional records may be produced by the system of the present application. For example, FIGS. 15A, 15B, and 15C show an embodiment of a first 1502, second 1504, and third page 1506, respectively, of a Member Provider Medication Record 1500 of the system of the present application. The Member Provider Medication Record 1500 may be, in part or in whole, in letter-format addressed to at least one prescribing physician 470, provider physician 526, and/or caregiver/doctor 377, and may include a medication narrative 1508 comprising information obtained from a Member 132 regarding the medications the Member 132 is taking.

FIGS. 15B and 15C show an embodiment of a second page 1504 and a third page 1506, respectively, of a Member Provider Medication Record 1500 of the system of the present application. The Member Provider Medication Record 1500 may include contact information for a health care manager 360, and a prescription narrative 1500 comprising information on one or more prescribing physicians 470 and the medications prescribed by the prescribing physician(s) for the Member 132. The Member Provider Medication Record 1500 may also include a targeted medication summary 1512 comprising information on one or more medications taken by a Member 132 under different circumstances, for example when a Member 132 has, different levels of blood sugar in his or her body at a given time.

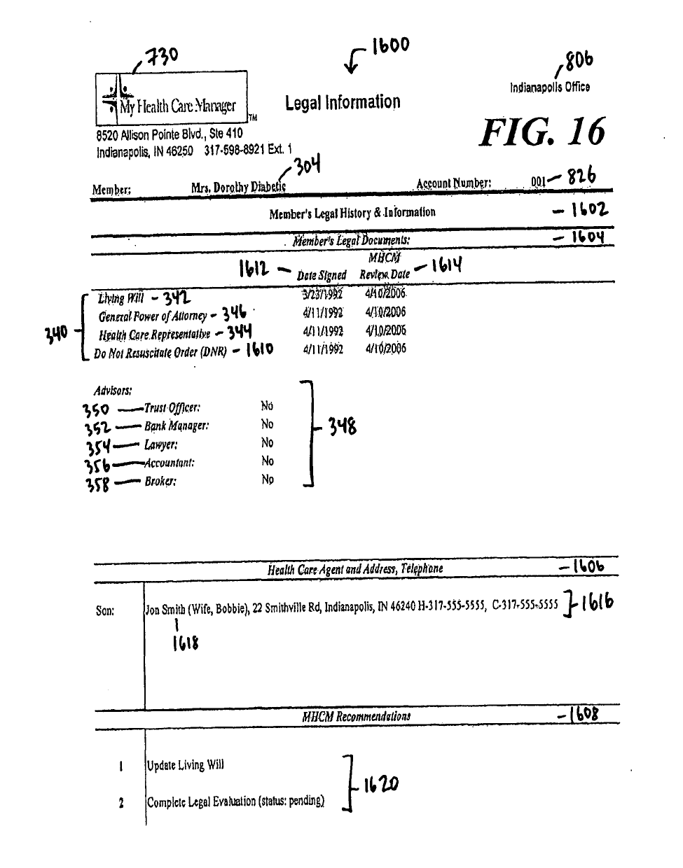

FIG. 16 shows an embodiment of a Legal Information Report 1600 of the system of the present application. The Legal Information Report 1600 may include a “Member's Legal History & Information” heading 1602, and may include subheadings for “Member's Legal Documents” 1604, “Health Care Agent and Address, Telephone” 1606, and “MCHM Recommendations” 1608. The Member's Legal Documents subheading 1604 may include information on the Member's 132 advance directives 340, including, but not limited to, a living will 342, a general power of attorney 346, a medical power of attorney 344 (shown as “Health Care Representative” in FIG. 16), a do not resuscitate order (DNR) 1610, along with signature dates 1612 and review dates 1614 for the documents listed within the Member's Legal Documents subheading 1604. In addition, the Member's Legal Documents subheading 1604 may also include information pertaining to a Member's 132 related advisors 348, including, but not limited to, a trust officer 350, a bank manager 352, a lawyer 354, an accountant 356, and a broker 358. The Health Care Agent and Address, Telephone subheading 1606 may include, but is not limited to, health care agent contact information 1616 so that a health care agent 1618 may be contacted as necessary. The MCHM Recommendations subheading 1608 may include at least one legal recommendation 1620, for example, a recommendation that a Member 132 update his or her living will 342.

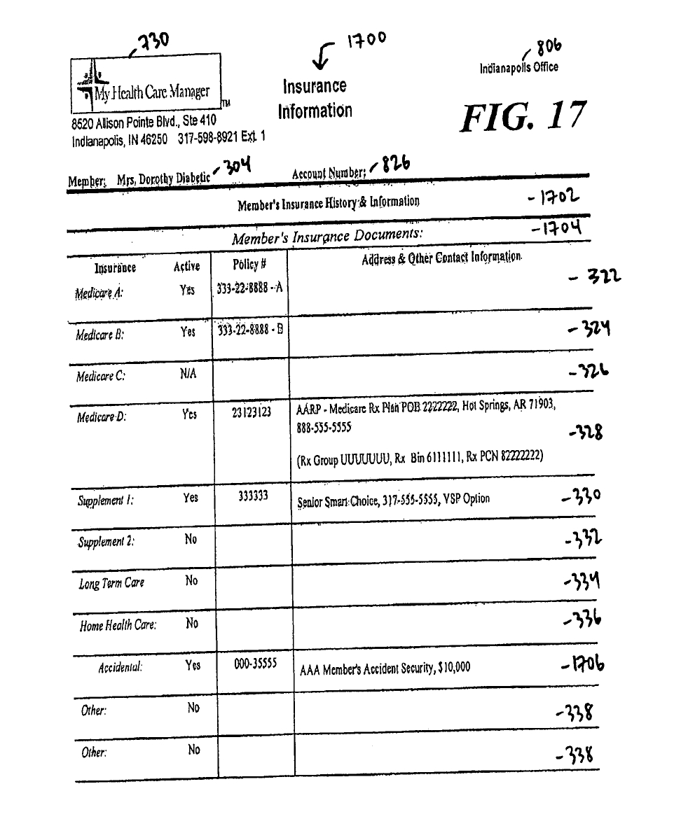

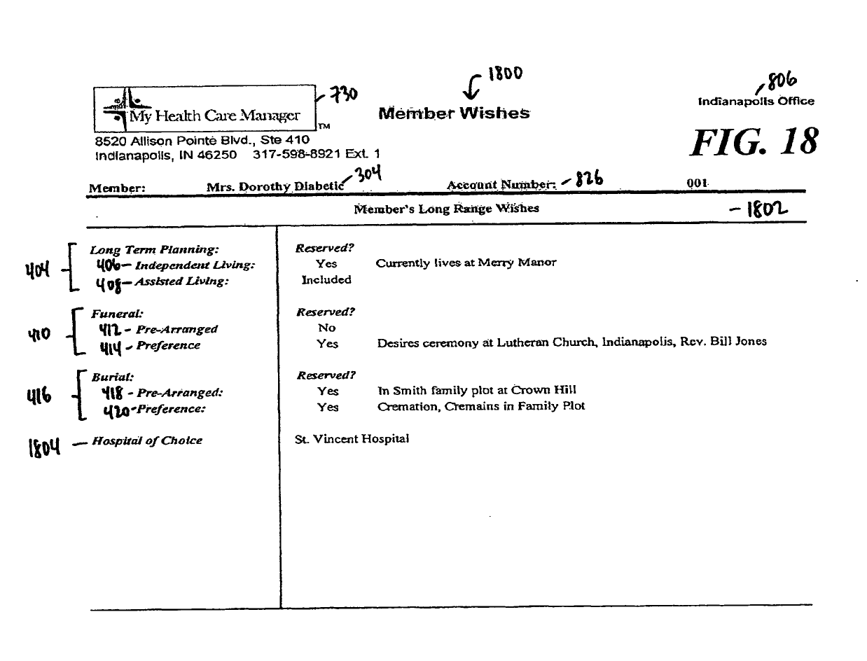

FIG. 17 shows an embodiment of an insurance Information Report 1700 of the system of the present application. The Insurance Information Report 1700 may include a “Member's Insurance History & Information” heading 1702, and may include a subheading for “Member's Insurance Documents” 1704. The Member's Insurance Documents subheading 1704 may include the Member's 132 insurance information 320, including, but not limited to, information pertaining to Medicare Part A 322, Medicare Part B 324, Medicare Part C 326, Medicare Part D 328, Medicare Supplement 1 330, Medicare Supplement 2 332, long-term health care 334, home health care 336, accidental care 1706, and other health care 338, including whether or not the insurance is active, the Member's policy number(s), and the insurance provider(s) contact information.

FIG. 18 shows an embodiment of a Member Wishes Report 1800 of the system of the present application. The Member Wishes Report 1800 may include a “Membe's Long Range Wishes” heading 1802, and may include information pertaining to the Member's long-term planning 404 (including independent living 406 and assisted living 408 information), funeral 410 information (including pre-arrangement 412 and preference 414 information), burial 416 information (including pre-arrangement 418 and preference 420 information), and information pertaining to a Member's 132 hospital of choice 1804. Information pertaining to whether or not a Member 132 has reserved long-term planning 404, funeral 410, and burial 416 arrangements may be included, and may provide the Member's 132 preferred locations for each.

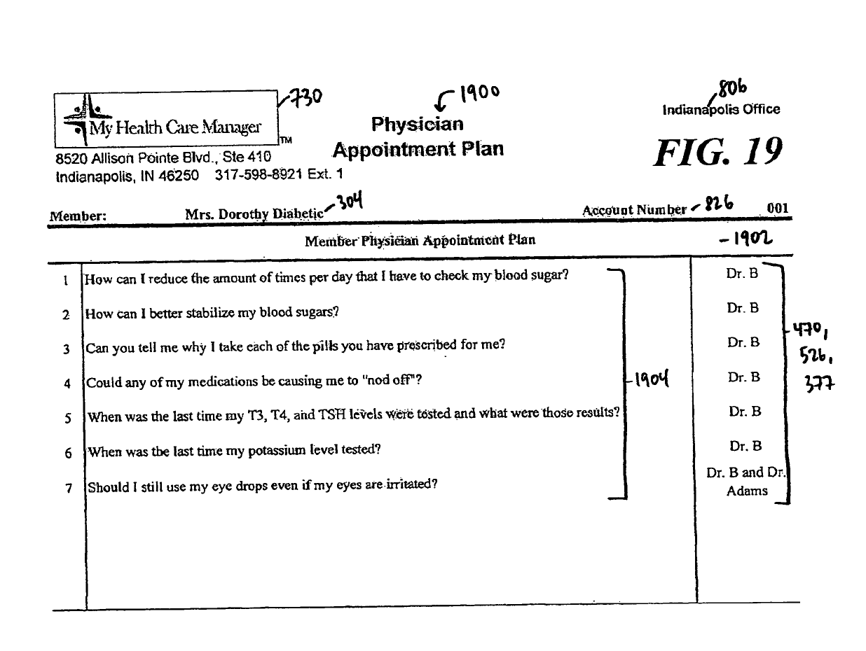

FIG. 19 shows an embodiment of a Physician Appointment Plan 1900 of the system of the present application. The Physician Appointment Plan 1900 may include a “Member Physician Appointment Plan” heading 1902, and may include one or more questions 1904 that a Member 132 may, wish to ask his or her prescribing physician 470, provider physician 526, and/or caregiver/doctor 377.

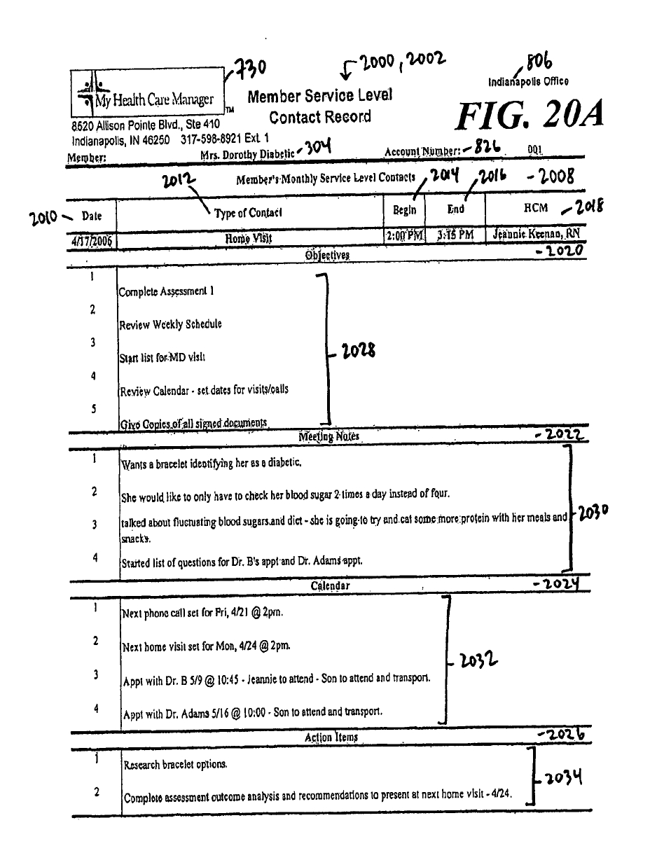

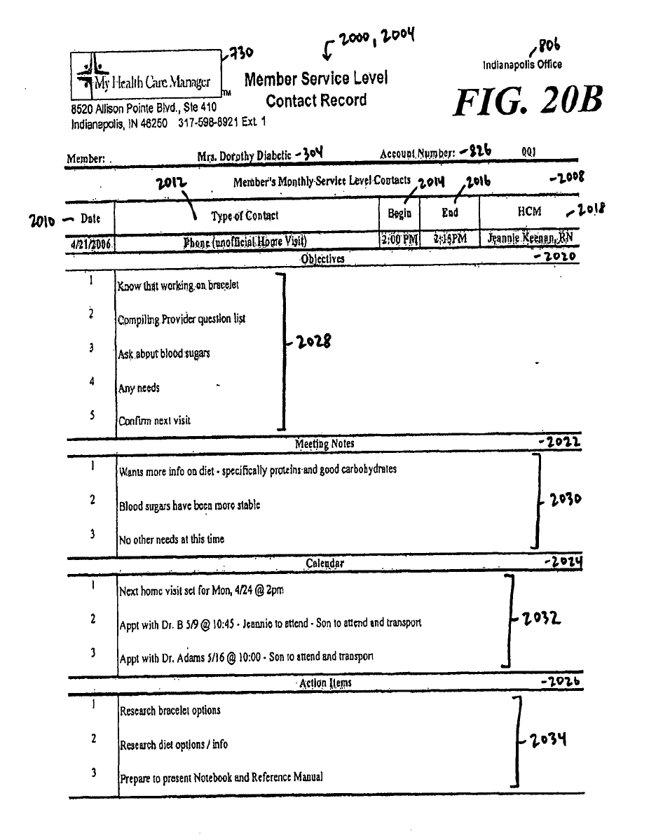

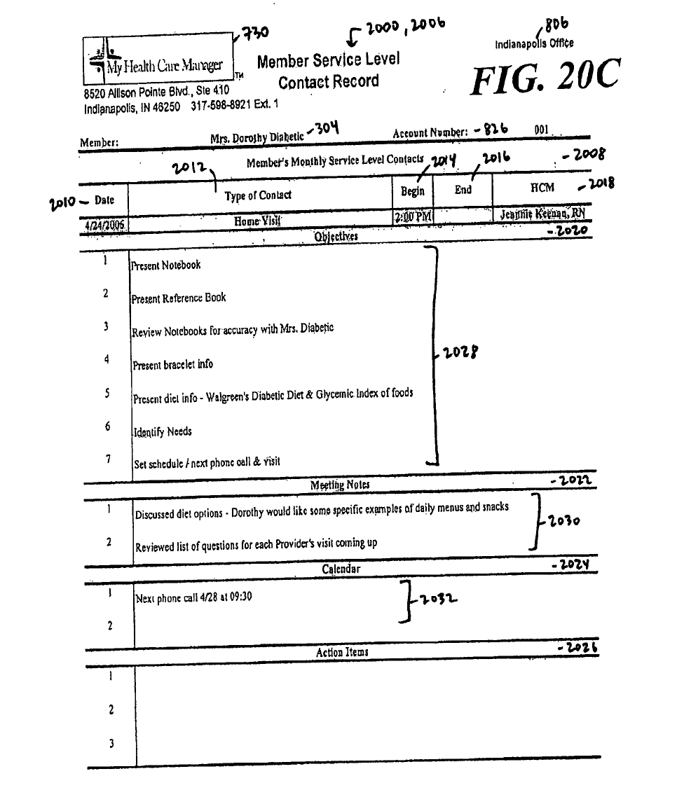

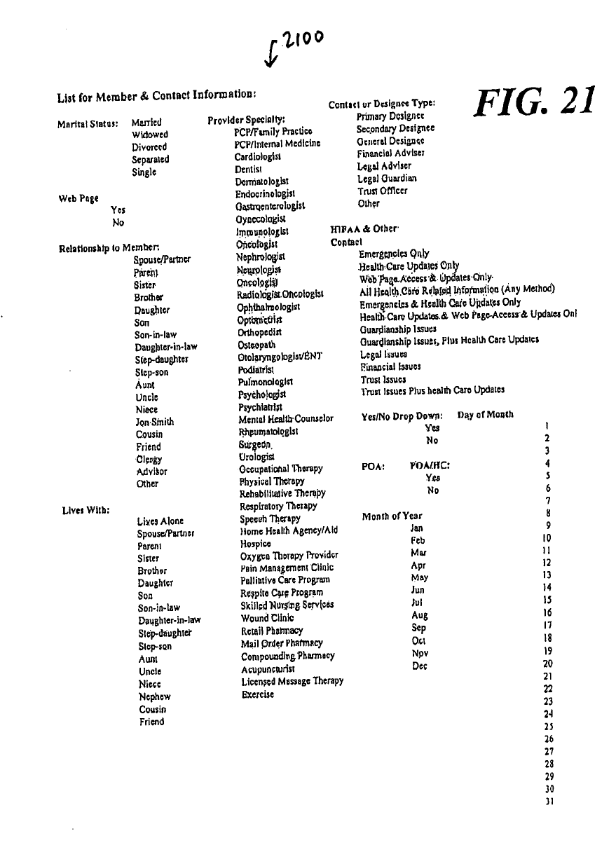

FIGS. 20A, 20B, and 20C show a first 2002, second 2004, and third 2006 example of a Member Service Level Contract Record 2000 of the system of the present application. The Member Service Level Contract Record 2000 may include a “Member's Monthly Service Level Contacts” heading 2008, and may include subheadings for “Date” 2010 to show the date 462 of a contact, “Type of Contact” 2012, “Begin” time 2014 of the contact, “End” time 2016 of the contact, “HCM” (2018, the “Health Care Manager” involved with the contact), “Objectives” 2020, “Meeting Notes” 2022, “Calendar” 2024, and “Action Items” 2026. Information within the Type of Contact subheading 2012 may show the type of contact, including, but not limited to, a home visit 12, provider visit 14, phone consult 16, pharmacy visit 18, and/or a family communication 20. Information within the Objectives subheading 2020 may include at list of one or more health care objectives 2028 for a Member 132 to follow. Information within the Meeting Notes subheading 2022 may include a meeting summary narrative 2030 referencing one or more items discussed with a Member 132 during one or more Member Visits. Information within the Calendar subheading 2024 may include a future appointment narrative 2032 referencing the Member's 132 upcoming Member Visits and appointments with his or her prescribing physician 470, provider physician 526, and/or caregiver/doctor 377. Information within the Action Items subheading 2026 may include an action item narrative 2034 referencing specific action items a Member 132 should perform after a Member Visit.

FIG. 21 shows an embodiment of an Item Selection List 2100 of the system of the present application. The Item Selection List 2100 may include a number of items to be chosen under a particular heading. For example, a system user wishing to select a particular marital status 818 may select from a list comprising the selections of “married,” “widowed,” “divorced,” “separated,” and “single.” It can be appreciated that any number of the individual pieces of information to be provided by or obtained for a Member 132 may include its own list of selections to choose from.

It can be appreciated that any number of the individual records and/or reports referenced herein may include, but are not limited to, general contact information and office location information for the organization that prepared the record(s) and/or report(s), and that the record(s) and/or report(s) may also identify a Member's full name and account number.

It can be appreciated that any number of the individual records and/or reports referenced herein may also include a confidentiality statement to denote the confidential nature of the information contained within the individual record and/or report.

It can be appreciated that any number of the individual records and/or reports referenced herein may include information that was either provided by data previously entered into the health care management system or that was entered directly by a Member.

It can be appreciated that any number of the individual records and/or reports referenced herein may include several duplicate sections to allow, for example, information regarding multiple physicians, medications, appointments, and the like, to be referenced within an individual record and/or reports.

It can be appreciated that the individual records and/or reports referenced herein, as well as additional records and/or reports incorporating some or all of the individual data elements referenced herein, may be modified, amended, and/or produced within the spirit of the system of the present application. In addition, it can be appreciated that the individual records and/or reports contain data and information provided by one or more databases of the system of the present application, which may also allow for additional records to be generated from the data within the database(s).

It can be appreciated that the entry of information into a system of the system of the present application may occur once or multiple times, and the information entered may be used on any number of records and/or reports as disclosed herein.

It can be also appreciated that the information appearing on multiple pages of one or more records and/or reports as disclosed herein may appear at different locations on the same page of a record and/or report or on different pages of a multiple-page record and/or multiple-page report.

### EXAMPLE 1

### My Health Care Manager

The following is an example of one embodiment of the implementation of the system and method of the system of the present application.

Introduction

My Health Care Manager, LLC (“My Health Care Manager”. “Company”) provides selected health care management services to its client(s) “Member(s)”) in a recurring, monthly service business model, Services may be provided by Health Care Managers who are registered nurses and/or social workers.

My Health Care Manager's strategic informatics approach and database of Member information may provide a secondary benefit to Members. Multiple factors in each Member's Personal Health Care Record may be tracked and analyzed to better understand their impact on the quality of seniors' aging experiences or on the general quality of health care of its Members. Information may also be shared with geriatric health care professionals and researchers to advance the state of knowledge in predictive indicators for health care among older adults.

Need

Many individuals for varying reasons need help with managing their personal health care programs. Due to the specialization of the medical care profession and, therefore, frequent involvement of multiple physicians and ancillary health care providers with the complications of insurance coverage and reimbursement practices, the potential for confusion presents a very real need for assistance. The problem is compounded both for the care-seeking: individual and relatives or caregivers especially if they are not located close to their loved one or are unable to assist. The system of the present application may allow for these specific needs and problems to be met and/or solved by providing the Member services as discussed herein.

Services

No medical care is provided by the Company or the Health Care Manager; rather, the Company helps manage, or “navigate,” the care and services provided by others. Members may be able to select from a series of different monthly program levels designed to provide different degrees of service depending upon the Member's current needs and are adapted to their changing needs. The services may include, but are not limited to, optimization of a Member's health information, including medicines, contacts, care plans, insurance, advisors, family and support members, in one location, while the Member's Health Care Manager keeps the information up-to-date in a computer-based My Health Care Manager's Personal Health Care Record^{SM} that is visible to permitted loved ones and providers via a secure Web: site and printed for retention and reference in their Member's Notebook. A Member may also be provided with an up-to-date small, personal ready reference card with important physician, medicine and contact information for doctor office visits and/or emergencies.

In addition, a service provider may also review a Member's health information for gaps or overlaps and pointing out possible improvements for them and/or their advisors to investigate—even including yearly reviews of their Medicare D or other prescription drug coverage. A Health Care Manager may also visit a Member to conduct assessments to provide a perspective of their relative health status and guidance on services that best fit their current situation, while continuously documenting changes over time. In addition, a Health Care Manager may also visit and/or call Members to stay in close contact and remind them of upcoming doctor office or clinic appointments and renewals or refills of prescription medicines. Members may also obtain assistance with understanding and challenging, if necessary, health care bills and insurance claims.

Members may also receive a My Health Care Manager's Weekly Schedules^{SM} that provides a daily log of medicines and health care activities to aid Members and their physicians in ensuring compliance with their recommended health care plans. In addition, a Health Care Manager may also coordinate family communications, including providing a secure Web page for viewing the Personal Health Care Record and regular status updates by those not living close to the Member, if the Member so desires. Members and their loved ones may also receive assistance in understanding and exploring alternative living options, if or when they are interested. One skilled in the art can appreciate that several customized related services may be tailored by the system of the present application in order to meet the unique needs of a Member.

Services, Benefits and Proprietary Decision Aids

The services of My Health Care Manager are designed to manage the complicated and confusing aspects of a Member's personal health plan and to help the Member maintain his or her independence as long as desired or safe. Indistinguishable goals of “independence” and “peace of mind” are aided by the direct involvement of a Health Care Manager with the Member's personal health care plan.

There are multiple beneficiaries of My Health Care Manager's services. The senior individual with current or future needs, the Member, is the primary direct beneficiary and the ultimate customer. The Company's plans estimate the majority of membership decisions are made by the Member directly or shared in consultation with other advisors including children, doctors, attorneys or financial advisors.

Other direct beneficiaries for My Health Care Manager's services are children, relatives or caregivers who may be unable or too beleaguered to provide similar services for their parent sibling or friend due to the distance or other complications. The mental and economic stresses (and oftentimes guilt) felt by these distant caregivers, many of whom have demanding careers and families, are well known. With permission from the Member, these remotely located caregivers are able to monitor the Member's status via a secure Internet connection and have discussions with the Health Care Manager thereby providing valuable and unique assistance for the major needs of remote caregivers and relatives.

Additional beneficiaries are physicians, health care agencies, hospitals and professional advisors for the Member. By having health information in an accurate and up-to-date form and an experienced Health Care Manager to communicate and work with, the quality of service provided by those professionals and organizations may be enhanced and the delivery of their services may be made more effective and productive.

Initial Services. Initial services that Members receive may commence with a Health Care Manager's visit to become acquainted with the new Member. At that meeting the Health Care Manager may obtain HIPAA-compliant consents, conduct an assessment of the Member's health status, and obtain information necessary to create the Member's comprehensive My Health Care Manager's Personal Health Care Record^{SM}. Health insurance and Advance Directives may also be obtained for scanning into the Personal Health Care Record and for subsequent analysis and recommendations. A Member (and those in which a Member may grant access) may then obtain secure and private access to his or her health information from the Company's proprietary computer system on the Company's website.

Member Service Levels. Members may choose specific service levels to meet his or her unique needs, also allowing for custom service levels if desired. The individual service levels may include monthly updates to a Member's health information, and may also include telephone or personal visits as needed or desired. Members who are living active and independent lives and do not require special assistance may select only minimal service, wherein a Health Care Manager provides periodic Member contact to observe changes and to update the Member's health information. If additional assistance is needed, for example, assistance with monitoring the Member's medical treatment plans and medications, more frequent telephone or personal visits may be provided. Periodic Member re-assessments may be performed by a Health Care Manager to update the Member's health care record as changes occur throughout the year. A Health Care Manager may also monitor the Member's interactions and schedule with his or her health care providers and update records for new treatment plans, results from visits with doctors or health care delivery organizations, medication changes and future appointments. A Member may also receive telephone reminders from a Health Care Manager regarding upcoming appointments, and the Health Care Manager may also make post-provider-visit phone calls to the Member to track compliance with medications and treatment orders and may also post results to the Member's private Web page for viewing by caregivers, if permission has been granted by the Member. A computer generated My Health Care Manager's Personal Weekly Schedule^{SM} may also be supplied to the Member to provide a daily reminder and log of medications (prescription and over-the-counter), appointments and related events. A Member may also receive more frequent home visits by a Health Care Manager as needed, for example, on a weekly or monthly visits. Members may also obtain assistance regarding his or her assisted living situation from a Health Care Manager. Members requiring long-term care may receive personal visits on a periodic basis, which may include monitoring the Member's living environment and situation, and may also receive assistance by a Health Care Manager regarding the Member's specific long-term care facility. Additional services may be provided at a level designed to meet unique needs of Members and their families.

Additional services may also be provided to a Member, including, but not limited to, transportation to and from health care providers, reconciliation (and appeal, when necessary) of a member's health care bill, and assistance with obtaining improved health care insurance. In addition, a Member may also receive service regarding unplanned events, like assistance for a hospital admission or a related health care crisis, and a Health Care Manager may also provide assistance with coordinating a Member's family as needed for a Member for a particular health care event or emergency. A Member may also obtain assistance regarding residential living options, as well as assistance with ordering and receiving prescription and non-prescription medications.

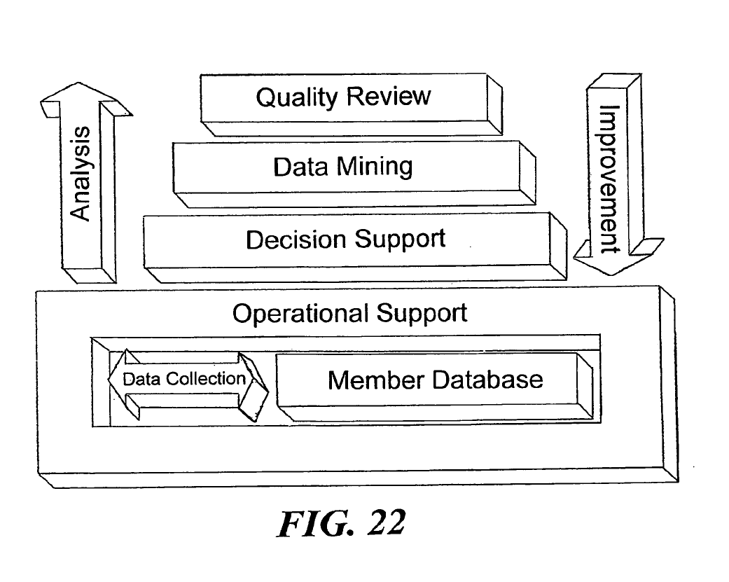

Health Care Managers are provided with reinforcement of all service delivery processes through defined workflow management Delivery and data are standardized at a level significantly more detailed than current industry case management practice. The Informatics content develops in four layers and as shown in the Knowledge Development Layers figure (FIG. 22):

1. Operational Support—Enforcing processes and health care management standards of care established by My Health Care Manager, its Advisory Board, and industry standards. Process enforcement creates an opportunity to determine what is salient in each of the assessment areas and further refine the data elements collected. For example, the Member Initiation Process is enforced through the use of conditional workflows in the system. This includes collection of information for review, building of the health record, performing screening assessments, follow-up contacts, and all steps in the management process. Analysis of the consistent data will expand or eliminate data elements collected.

2. Decision Support—Differentiating protocols for health management practices determined by the results of scored assessments and changes in Member health status over time. This layer affords focused exploration to make decisions about levels of independence. For example, during an in-home visit a Health Care Manager may identify an indicator prompting a screening in one or more of the assessment dimensions. The results of this rescreening are compared to past results to identify significant changes prompting action, provider follow-up, or other recommendations to the Member and their family. In addition, the systems provide concrete standards based feedback using criteria like ACOVE (Assessing Care of Vulnerable Elders) for quality of care and HCQI (Home Care Quality Indicators) for assessing home care.

3. Data Mining—Improving protocols and developing predictive indicators based on trends in Member health information, assessment results, and patterns recognized in historical data, Identifying early indicators provides trustworthy findings regarding prognosis, so Members and their families can be prepared with resources needed to support the least restrictive living situation. For example, patterns in the screening assessments scores may indicate that early declines in some dimensions (i.e., safety and mobility) lead to particular outcomes (i.e., relocation from the home into assisted living) unless early intervention is obtained. These predictors will be entered to Health Care Manager processes to take early action and thus effect outcomes.

4. Quality Review—Identifying quality improvement areas and inadequate service delivery through audit and peer comparison against statistical care norms. The aggregated data collected through audit, peer evaluation, and inter-rater reliability will identify areas for improvement in best practices. For example, Health Care Managers who are not performing an adequate number of re-screening assessments during in home visits can be identified. Individuals are compared against statistical norms for their area and Member population. It is not reasonable to expect the same number of re-screenings to be completed by a Health Care Manager with Members having few health conditions when compared with those managing more complex cases.

With this advanced technology, reliability and validity can be established using triangulation with quantitative and qualitative methods. Only with this Informatics driven approach can the data be merged permitting massive amounts of assessment data to be integrated with a cross-sectional snapshot of all assessment areas and then making that data available for longitudinal study. This data is critical because no opportunities currently exist to assist in placing older adults in a high level of study control.

Future considerations include the possibility of predictive mining of aggregated Member data in comparison with an individual. Member by that Member or their family. This could allow Members or family to better understand what they can expect in a developing health situation. Another area of interest is the integration of Member data with Electronic Medical Records (EMRs) as these systems emerge in the health care industry. Medical records would be combined into the Personal Health Care Records^{SM} and correlated with the other dimensions tracked by My Health Care Manager. This would enable more extensive analysis of patterns and results of clinical care.

These are key elements for delivering measurable improvements in the lives of Members. They are: also essential to the quality of service, scalability, and efficiency of the service provider. The multidimensional relational database combines data on each senior Member in four (4) demographic, six (6) health, and eight (8) health-related dimensions. Each of these dimensions represents numerous current state and longitudinal data elements. The database is the platform on which advanced analysis and discovery is based.

Equally important to the data, is the data collection mechanism. The consistency and completeness of data maintained in the system is enforced by My Health Care Manager's trained, professional Health Care Managers, detailed business processes, and application systems. This is the first information layer implemented on the database platform. None of the other Informatics layers can be successful without the implementation of these two elements. The two elements together create a unique repository for analysis, discovery, and practical improvements in seniors lives.

My Health Care Manager is being developed to provide necessary services to older adults and their families to assist them in managing and navigating their health care worlds. The systems underlying the service delivery are essential to this mission and represent a major advance in Health Informatics. The Company has developed an integrated health care record, health care plan, and case management system that is made available to recipients of care and their families, care managers, and health care professionals. With the technology, Member data, and resulting data model, innovation is possible in understanding care plans and outcome relationships. Such innovation will contribute to the knowledge and advancement of health care for older adults.

The heterogeneous data types stored in the database are both qualitative and quantitative in nature. These data types will be transformed: into numerical aggregates during the data preprocessing stage. These numerical aggregates are categorized into several groupings to be mined. Then association rule mining is used to find causal relationships among layers for analysis of thematically associated events.

The Decision Support, Data Mining, and Quality Review layers involve finding associations among manly variables collected on each Member. Consistently with other Informatics applications, an association is de-fined as a bi-directional implication between two objects in form of A→B, where A and B are two objects or set of objects of interest and A is an antecedent and B is consequent, or vice versa; for example, a visual acuity score and a fall. Automatically generating associations can help to improve decision-making speed and accuracy. My Health Care Manager will be finding associations or relationships amongst various objects of interest and extracting knowledge for use with Members. To facilitate such automatic knowledge extraction various discovery processes have been proposed.

One such technique, association rule mining, will be used to discover interesting associations between attributes contained in a database. A classical application example is market basket analysis, where the desire is to determine those items likely to be purchased by a customer during a shopping experience. The output of the market basket analysis is a set of associations about customer-purchase behavior. Considering this idea in the health context, certain changes in one or more assessed dimensions may predict certain Member health outcomes. For example, loss in visual acuity combined with increased challenges in Activities of Daily Living (ADLs) may lead to a health incident like a fall. Many of the associations may be less obvious. Analysis will also help uncover intervention strategies. For example, installation of assistive devices may influence the associative outcome referenced above.

Association rules are unlike traditional classification rules in that an attribute appearing as an antecedent (precondition) in one rule may appear in the consequent of another rule. Association rule generators allow the consequent of a rule to contain one or several attribute values. Likeliness of antecedent leading to consequent is answered by confidence associated with an association rule. An association rule confidence is the conditional probability of consequent given an antecedent. In the example referenced above, this would identify the likelihood that a fall will occur give particular vision and ADL scores. Another important piece of information is the percent of all transactions containing the attribute values found in an association rule. This information is known as the support for a rule. Support is the minimum percentage of instances in the database that contain all items listed in a specific association rule. In addition, My Health Care Manager has explored association discovery techniques for geographical information systems data mining using apriori algorithms known in the art with academicians under contract.

How this information is presented and understood will require the development of advanced visualization techniques. Information Visualization and Visual Analytics play an increasingly important role in health care data management and data mining applications. Information visualization refers to the visualization of non-visual and abstract information to provide interactive and multi-scale views of the data and its properties; for example, visualizing multiple assessment dimensions, or even associative rules.

Visual Analytics applies interactive information visualization to carry out visual reasoning and visual data mining tasks, and can often be more effective and intuitive than conventional data analysis methods. The data present in the Member Database may include case narratives, daily logs, notes, medical records, etc, Many of these are large scale unstructured text sequences with possible numerical or categorical attributes. The text can be fragmented with unreliable grammatical structures, which is very difficult to analyze. Proper visualization and visual reasoning of such text sequences and their attributes can reveal visual patterns and trends that may greatly impact the design, monitoring, management and improvement of the Member's health situation.

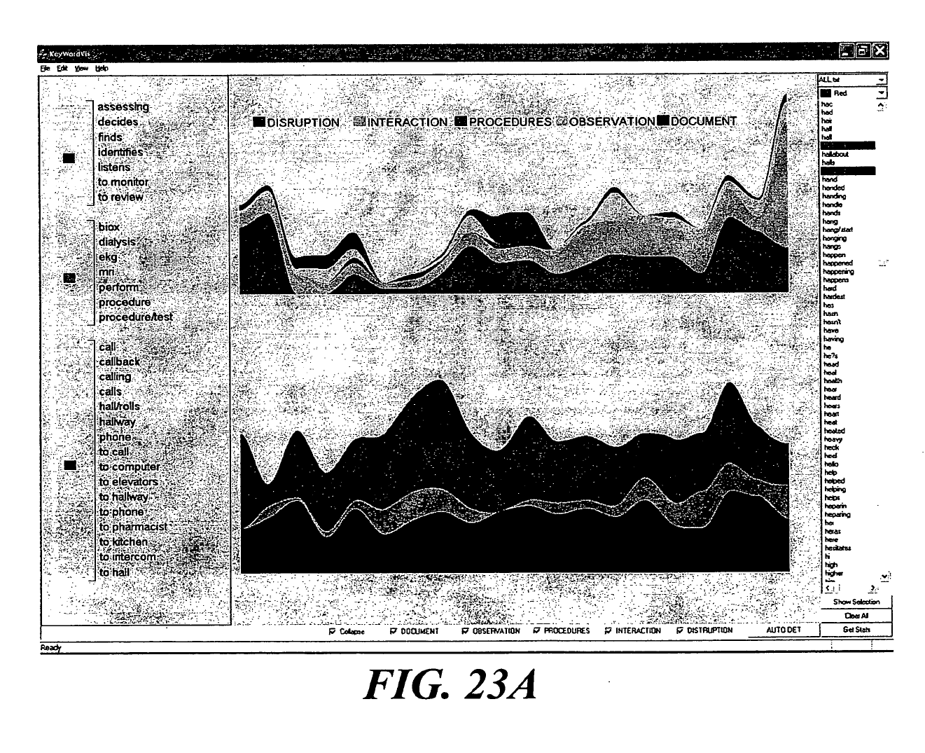

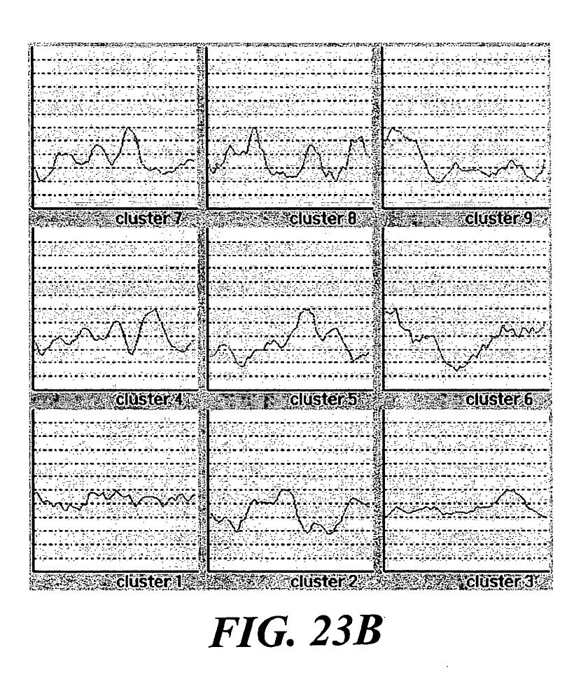

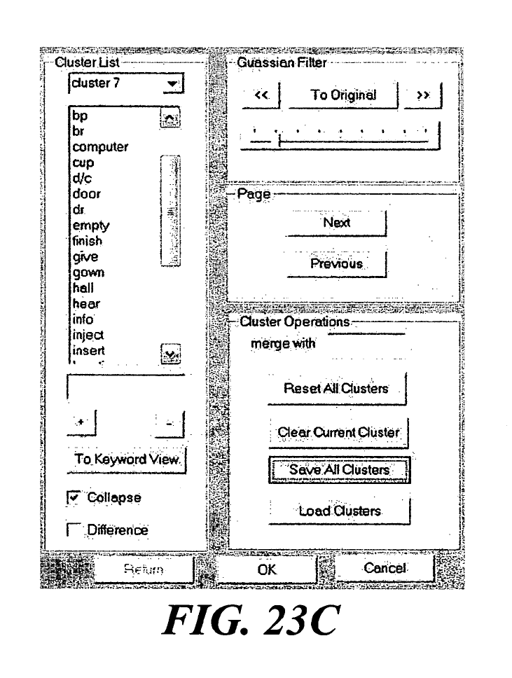

In addition, My Health Care Manager has explored the development of multi-scale keyword-based visualization and visual analytics techniques in collaboration with academicians under contract. Both icon-based and theme-river visualization methods will be used to represent the occurrence and distribution of keyword structures that represent certain concepts or interested events at various levels and interest scales. A semantic tree structure will be used to allow the automatic detection of hierarchical events and concepts from unstructured text data sequences. These semantic trees can either be pre-defined for known and common concepts and events, or automatically detected using a visual analytics technique called Iterative Visual Clustering (IVC). Iterative Visual Clustering combines interactive visualization and visual reasoning through user feedback to iteratively cluster keywords using various image operators to discover new concepts and events that exhibit patterns and trends of interest to Health Care Managers and quality improvement initiatives. FIG. 23 shows an example of this method applied to nursing data.

Technology Development Roadmap

My Health Care Manager's technology backbone is comprised of two core systems Navigator and Compass. The My Health Care Manager Navigator System^{SM} (“Navigator”) is a suite of applications which provide the core field functionality for providing service to Members. The Compass System is a standard ERP application for business operations combined with custom extensions and custom interface modules for integration. Navigator is the proprietary integrated software application developed to enable and support the services offered by the Company. The system provides a Member information repository, quality control, communication and work, scheduling platform for the key stakeholders in providing health care management, including:

(a) Health Care Managers;

(b) Health Care Associates;

(c) Team Managers;

(d) Area Managers;

(e) My Health Care Manager Members;

(f) Member Designates (Family, Friends, etc.);

(g) Health Care Providers;

(h) Expert Reviewers; and

(i) Processing Associates.

The Company is currently developing 12 technology tracks. The core tracks in Navigator required for the Company's technology are the most advanced and active. Navigator is comprised of four key sub-systems:

(a) Navigator Health Care Manager;

(b) Navigator Knowledgebase;

(c) Navigator Member; and

(d) Navigator HCP (Health Care Professional).

The development of these systems are being phased. To speed this phased approach and reduce the development risks and cost, commercially available applications have been selected and integrated where applicable. An extensive evaluation process examining more than 30 applications have resulted in the selection of an existing case management system, ClientTrack.NET™, in use for over 10 years in commercial and government applications. Navigator Health Care Manager and Navigator Knowledgebase are built on this proven platform. The current version is implemented as an N-Tier application separating the Presentation, Business Logic, and Data components of the application. The implementation on current technology platforms provides a highly customizable application framework. The specific technologies include:

(a) Microsoft.NET application framework—ASP.NET and IIS;

(b) Microsoft SQL Server relational database;

(c) Microsoft ADO.NET data access; and

(d) C#-primary development language.

These underlying technologies and architecture provide scalability and extensibility.

Navigator Member is a custom development effort. This sub-system is designed as a portal implementation based on rapidly deployable Internet portal construction tools easily tailored to the Member application.

Navigator HCP is planned for future implementation using similar portal technology. The Compass System has been developed using a similar process of evaluating and selecting commercial products, customization, and construction of integration applications. This product evaluation is complete and a core suite of applications has been selected and launched. Implementation and customization are also underway for the CRM, Billing, and Financial components of the system.

The remaining systems are in various early stages of the development life cycle. To speed the integration of the Navigator sub-systems within Navigator, with Compass, and with other My Health Care Manager applications, particular attention has been paid in commercial application selection by use of the following:
(a) XML integration capabilities including native support, Import, and Export;
(b) Web Service Application Programming Interfaces (APIs) in .NET and/or J2EE; and
(c) Industry leading non-proprietary Relational Database platforms (e.g. SQL Server, Oracle) and data models published to the client.

Risks to developing this core technology center on security and HIPAA compliance. These risks are well known and compliance and mitigation strategies are being developed. While likely not a HIPAA “covered entity”, My Health Care Manager realizes that it is dealing with sensitive and personal information. Many people the Company will interact with will be covered entities or “business affiliates” and My Health Care Manager expects to assure them of its HIPAA compliance.

Commercialization Plan and Challenges

The commercialization strategy is to expand operations after a successful Indianapolis pilot by using proven consumer marketing tactics including public affairs, public relations, influencer education, direct data base targeting, sophisticated and high quality direct mail, secondary mailings to relationships, and a customer relationship management system. The National Plan will derive its growth from Web site-generated inbound calls augmented by paid Web search advertising. When enough areas are operating along with the National Program, insurance brokers will be contracted to present the plan to large employers for their offering as an employee benefit, on a selective basis. The key marketing challenge is to discover if targeted seniors and their loved ones will want the services and be willing to pay for theme. Interviews and a focus group indicated that proposed services and planned charges are desirable and reasonable. Since all systems and training are centrally controlled, changes will be possible in quick response to what is learned in the marketplace regarding current services and possible new ones.

Competitive Advantages

Although a directly competitive model in the market has not been discovered, others will follow as the Company attracts publicity and financial results. My Health Care Manager's Informatics driven approach will be difficult to copy. The strategy to attain competitive advantage is the rapid expansion to key areas made possible by the extensive use of informatics in the design of My Health Care Manager, followed by the introduction of the National Plan. Sustained competitive advantage will come though the use of Advanced Health Informatics, continuous quality improvement, rapid introduction of new services and changes to existing ones, and the critical mass from being the “first mover” in the new senior services segment.

Processes

My Health Care Manager is committed to defined, documented and measured processes All processes and sub-processes follow this policy. The Company recognizes that the ability to deploy, operate and provide assured services is based on a process engineered commitment, implementation and operations. All document processes and sub-processes are developed and maintained to drive technology, methods and procedures, and training supports. All are maintained for review and audit for compliance with best industry practices and HIPAA requirements.

Technology

Proprietary enhancements to an advanced and proven case/care management system are being made to create the My Health Care Manager Navigator System^{SM} (Navigator) to meet Company, and Member needs. Proprietary and unique features of Navigator include:
(a) Web-based development of the My Health Care Manager Personal Health Care Record^{SM} by Health Care Managers.
(b) The My Health Care Manager Personal Weekly Schedule^{SM} to assist in managing compliance, prescription and over-the-counter medications, and provider appointments.
(c) Management and quality assurance outputs for overseeing operations.
(d) Prescription medication summaries for distribution to the Members' doctors and pharmacists.
(e) Wallet/purse cards (also referred to as ready reference cards) for Members listing physicians, providers, family contacts and medicines.

Training

Conventional instructor-led training modules are under development. After testing with initial Area Office deployments, the training will be converted to Web-based capability for di-stance learning and measurement with an integrated Learning Management System.

Individual Roles and Responsibilities

The Company may employ or utilize the services of people at several different levels. The Company may also tailor its service needs based on is specific formation, for example, the need for staff at main headquarters and leadership staff at different regions and/or locations. For example, a regional and/or local vice president may be involved with the recruitment of Team Managers and Health Care Managers, obtaining new Members, and focusing on quality and community relations. A Team Manager may have similar responsibilities, and may also focus on managing the Health Care Managers and providing general assistance when needed. A Health Care Manager, as discussed herein, directly provides services to a Member, and may also assist with obtaining and retaining Members and may be directly responsible for the quality of services performed for a Member.

The system and method of the present application can be further modified within the scope and spirit of this disclosure. This application is therefore intended to cover any variations, uses, or adaptations of the system of the present application using its general principles. Further, this application is intended to cover such departures from the present disclosure as come within known or customary practice in the art to which this system of the present application pertains and which fall within the limits of the appended claims.

I claim:

1. A health care management system comprising:
a database capable of receiving data;
a processor operably connected to the database, the processor having and executing a program and operational to:
receive patient data associated with a patient, said patient data obtained from at least one patient visit;
perform a multidimensional screening assessment of the patient information;
generate data from the multidimensional screening assessment;
store in the database at least part of the patient data and at least part of the multidimensional screening assessment data; and
generate at least one report from the stored data in the database.

2. The health care management system of claim 1, wherein the at least one member visit comprises one or more visits selected from the group consisting of a home visit, a provider visit, a phone consult, a pharmacy visit, and a family communication.

3. The health care management system of claim 1, wherein the patient data is received by entry of the patient data into a terminal within the system.

4. The health care management system of claim 1, wherein the multidimensional screening assessment comprises one or more assessments selected from the group consisting of home safety member depression, and a member's social support network.

5. The health care management system of claim 1, wherein the multidimensional screening assessment comprises one or more dimensions of the multidimensional screening assessment selected from the group consisting of demographic information, family, social support, representatives and key contacts, financial, legal, insurance, spiritual, support services, caregiver support, physical health, functional health status, emotional/psychological status, medication history, home/residential environment and safety, health prevention, and wellness.

6. The health care management system of claim 1, wherein the patient data received by the processor comprises data representative of at least one from the group consisting of member contact information, date of birth, social security number, insurance information, advance directives, related advisors, health care manager contact information, allergies, at least one medical issue, at least one treatment plan, at least one medicine, long-term planning information, family communications information, at least one home visit observation information, and payment information.

7. The health care management system of claim 1, wherein the patient data received by the processor comprises data representative of at least one from the group consisting of an electronic health record (EHR), an electronic medical record (EMR), a personal health record (PHR), and an electronic public health record (EPHR).

8. The health care management system of claim 1, wherein the patient data received by the processor comprises data representative of at least one from the group consisting of non-prescription drug information, medical appointments, exercise and therapy, blood pressure information, target weight information, diet and liquid information, and medicine reordering information.

9. The health care management system of claim 1, wherein the at least one report comprises a daily and/or weekly schedule.

10. The health care management system of claim 1, wherein the at least one report generated by the processor comprises a health care record including:
a member's contact information;
at least one medical issue; and
at least one medical provider selected from the group consisting of a caregiver/doctor, a prescribing physician, and a provider physician.

11. The health care management system of claim 1, wherein the at least one report generated by the processor comprises a health care record including at least one item of stored data residing in the database selected from the group consisting of member contact information, date of birth, social security number, insurance information, advance directives, related advisors, health care manager contact information, allergies, at least one medical issue, at least one treatment plan, at least one medicine, long-term planning information, family communications information, at least one home visit observation information.

12. The health care management system of claim 1, wherein the at least one report generated by the processor comprises a medicine reorder schedule including at least one item of stored data residing in the database selected from the group consisting of a prescribing physician, at least one prescription medication, a prescription number, at least one non-prescription medication, a medication quantity, a daily dose, an amount of medication refills remaining, a date of next refill, a pharmacy name, and a pharmacy phone number.

13. The health care management system of claim 1, wherein the at least one report generated by the processor comprises a weekly health care schedule including at least one item of stored data residing in the database selected from the group consisting of at least one prescription medication, at least one non-prescription medication, a time to take a medication, a day to take a medication, a list of medicines to take at a specific time, a blood sugar test, and blood sugar test instructions.

14. The health care management system of claim 1, wherein the at least one report generated by the processor comprises a prescribing doctor verification letter including at least one item of stored data residing in the database selected from the group consisting of a prescribing physician, a provider physician, a member's full name, a narrative, contact information for a health care manager, a prescription medication list, and a non-prescription medication list.

15. The health care management system of claim 1, wherein the at least one report generated, by the processor comprises a ready reference card including at least one item of stored data residing in the database selected from the group consisting of a member's contact information, emergency contacts, contact information for a health care manager, a member's advance directives, hospitalization information, allergies, reactions, a caregiver/doctor, a prescribing physician, insurance information, at least one prescription name, a dose, a time of dose, specific dose parameters, one or more reasons why a member is taking a particular medication, and a date a member began taking a particular medication.

16. The health care management system of claim 1, wherein the at least one report generated by the processor comprises a contact information record card including at least one item of stored data residing in the database selected from the group consisting of a member's contact information, marital status, other people, account number, contact information for a health care manager, office location information, enrollment date, service level, specific service level details, one or more emergency contacts, and one or more health care designee.

17. The health care, management system of claim 1, wherein the at least one report generated by the processor comprises a personal weekly schedule including at least one item of stored data residing in the database selected from the group consisting of a member's full name, a prescription name, one or more reasons why a member is taking a particular medication, a method for taking a medication, a time of dose, specific dose parameters.

18. The health care management system of claim 1, wherein the at least one report generated by the processor comprises a provider information record including at least one item of stored data residing in the database selected from the group consisting of a member's full name, a caregiver/doctor, a prescribing physician, a provider physician, a first physician specialty, a duration of patient treatment, a date of first physician treatment, at least one medical issue, a clinic/practice name, a physician prescriber confirmation, a date of last member appointment, a health care plan confirmation, and health care plan issue information.

19. The health care management system of claim 1, wherein the at least one report generated by the processor comprises a medication record for prescriptions including at least one item of stored data residing in the database selected from the group consisting of a prescription name, a caregiver/doctor, a prescribing physician, a provider physician, a dose, a method of taking a medication, a frequency of daily dose, a time of dose, specific dose parameters, a next refill date, and a prescription number.

20. The health care management system of claim 1, wherein the at least one report generated by the processor comprises a medication record for non-prescription medications, vitamins, and supplements including at least one item of stored data residing in the database selected from the group consisting of a non-prescription name, a caregiver/doctor, a prescribing physician, a provider physician, a dose, a method of taking a medication, a frequency of daily dose, a time of dose, specific dose parameters, a next refill date, and a prescription number.

21. The health care management system of claim 1, wherein the at least one report generated by the processor comprises an assessment results and recommendations record including at least one item of stored data residing in the database selected from the group consisting of an assessment number, an assessment completion date, an assessment manager name, an assessment type, an assessment category, an individual score, a total score, scoring guidelines, assessment identification information, at least one immediate goal, and at least one recommendation.

22. The health care management system of claim 1, wherein the at least one report generated by the processor comprises a member provider medication record including at least one item of stored data residing in the database selected from the group consisting of a caregiver/doctor, a prescribing physician, a provider physician, a prescription narrative, and a targeted medication summary.

23. The health care management system of claim 1, wherein the at least one report generated by the processor comprises a legal information report including at least one item of stored data residing in the database selected from the group consisting of a living will, a medical power of attorney, a general power of attorney, a do not resuscitate order, a trust officer, a bank manager, a lawyer, an accountant, a broker, a health care agent, and at least one legal recommendation.

24. The health care management system of claim 1, wherein the at least one report generated by the processor comprises an insurance information report including at least one item of stored data residing in the database selected from the group consisting of Medicare Part A. Medicare Part B, Medicare Part C, Medicare Part D, Medicare Supplement 1, Medicare Supplement 32, long term health care, home health care, other health care, and accidental care.

25. The health care management system of claim 1, wherein the at least one report generated by the processor comprises a member wishes report including at least one item of stored data residing in the database selected from the group consisting of long-term planning, funeral, burial, and a hospital of choice.

26. The health care management system of claim 1, wherein the at least one report generated by the processor comprises a physician appointment plan including at least one item of stored data residing in the database selected from the group consisting of a caregiver/doctor, a prescribing physician, a provider physician, and one or more questions.

27. The health care management system of claim 1, wherein the at least one report generated by the processor comprises a member service level contract record including at least one item of stored data residing in the database selected from the group consisting of health care objectives, a meeting summary narrative, a future appointment narrative, and an action item narrative.

28. The health care management system of claim 1, wherein the system is accessible by a user through a system portal.

29. A computer program having a plurality of program steps to be executed on a computer to manage the health care aspects of a member, the computer program comprising:
means for collecting patient data obtained from at least one patient visit;
means for receiving multidimensional screening assessment data;
means for storing in the database at least part of the patient data and at least part of the multidimensional screening assessment data; and
means for generating at least one report from the stored data in the database.

30. A computer based method of operating a health care management system, the method comprising:
providing a system comprising a database and a processor operably connected to the database;
receiving patient data associated with a patient, said patient data obtained from at least one patient visit;
performing a multidimensional screening assessment of the patient data;
generating data from the multidimensional screening assessment;
entering with a processor patient data and multidimensional screening assessment data;
storing with the processor into a database at least part of the patient data and at least part of the multidimensional screening assessment data; and
generating with the processor at least one report from the stored data in the database.

31. A health care management system comprising:
at least one database comprising data relative to health care, the system operable to analyze data as to procurement of at least one medical appointment, at least one medication, and at least one medical test necessary to generate and/or maintain a health care plan.

32. A health care management system utilizing an informatics-based service delivery approach comprising:
at least one database and content developed regarding two or more of the following: service operational and decision support, predictive data mining, and advance quality analytics.
